(19) United States
(12) Patent Application Publication
(10) Pub. No.: US 2004/0123154 A1
(43) Pub. Date: Jun. 24, 2004

(54) System and method for validating security access across network layer and a local file layer

(76) Inventors: Alan Lippman, Seattle, WA (US); Chris James Carden, Seattle, WA (US)

Correspondence Address: GRAY CARY WARE & FREIDENRICH LLP, 2000 UNIVERSITY AVENUE, E. PALO ALTO, CA, 94303-2248, US

(21) Appl. No.: 10/625,764

(22) Filed: Jul. 22, 2003

Related U.S. Application Data
(60) Provisional application No. 60/397,504, filed on Jul. 22, 2002.

(51) Int. Cl. H04L 9/00; G06F 15/173

(52) U.S. Cl. 713/201; 709/223; 709/229

(57) ABSTRACT

A system and method are provided that permit access to a local resource, such as a media content file, without the security warnings typically encountered. The system has a software component or set of components that validate a hyperlink to a local (or remote) resource in the context of the network security environment and securely allows that hyperlink to access local (or remote) resources without being subject to additional restrictions or user inconvenience. A method for generating the hyperlink is also disclosed.

### PRIORITY CLAIM/RELATED APPLICATIONS

This application claim priority under 35 USC§ 119(e) to U.S. Provisional Patent Application Serial No. 60/397,504, filed on Jul. 22, 2002 and entitled “An Invention for Validating Security Access Across a Network Layer and a Local File Layer” which is incorporated herein by reference.

### FIELD OF THE INVENTION

The invention relates generally to a computer-implemented system and method for accessing a local resource and in particular to a computer-implemented system for validating security access across a network layer and a local file layer.

### BACKGROUND OF THE INVENTION

Access to the local file system and similar local resources of a computer is generally restricted to prevent unauthorized access to a computer's files and to prevent malicious programs from running on the computer. Such restrictions can take the form of limitations on hyperlinks in network documents such as web pages, e-mail messages or other media which may be located on a network or on the local computer. On the local computer, restrictions may be enforced by the operating system, applications such as e-mail clients and web browsers, or middleware, drivers and plug-ins that interact with such components. On external computers to which the computer connects, restrictions may be enforced by web server or e-mail server software, proxies, firewalls or security software. Restrictions may take forms in which access to the desired local resource is prohibited, restricted, or subject to additional warnings or confirmation steps requiring additional user interaction.

Thus, it is desirable to provide a computer-implemented system and method for validating security access across a network layer and a local file layer that overcomes the limitations of the prior systems and it is to this end that the present invention is directed.

### SUMMARY OF THE INVENTION

The invention presented allows a software component or set of components to validate a hyperlink to a local (or remote) resource in the context of the network security environment and to securely allow that hyperlink to access local (or remote) resources without being subject to additional restrictions or user inconvenience. Additionally, the invention may provide faster response and lower overhead than previous methods. Additionally, the invention can allow security verification using the network layer when the computer is not connected to an external network. For example, users who rely on modems for connectivity are not required to dial in, and portable computers disconnected from their network function normally. Additionally, the invention allows documents or applications on a network (for example e-mail messages hosted on the World Wide Web) to hyperlink to local resources with higher security and lower user inconvenience. The invention also includes the steps necessary to create the hyperlink, although this part of the system is by nature very dependent on the specific application of the invention. The invention also includes the method for selecting the application that handles the local resources, when the local resource is accessed through the techniques of this invention, resulting in improved the security and reliability.

A particular implementation of the invention, the TrustCast™ media delivery system (described in the co-pending commonly owned which was incorporated by reference above), is presented which allows an email recipient to launch a pre-delivered media file with a single click from within an email program. While some email systems will allow this to be accomplished by using the HTML construct of file://filename within the email, others will generate a security warning or filter out such a link before it is ever presented to the recipient. The TrustCast™ system implements the invention described in this patent to avoid both security warnings, filtering and other processes that render simply sending a link in an email to file://fiename either undesirable or non-functional. This implementation of the invention also maintains the overall security of the system, and implements a security protocol that allows the local user to have access to media, while assuring that the only media that is linked has been securely delivered and validated by the TrustCast™ system.

The invention as implemented in the TrustCast™ media delivery system, has been effective for all common email systems, including email applications which are local (e.g. Outlook, Eudora, Outlook express) or remote (e.g. Hotmail, Yahoo mail) or a combination (e.g. a local application that displays emails on a web page, such as AOL 6.0 or 7.0 mail). The implementation entails a set of components, hereafter referred to as the TrustCast™ Local Server, and the TrustCast™ Local Application, that run at least partly on the recipient's computer and that communicate via both the local and network protocols. The TrustCast™ Local Server may or may not run locally and accepts requests for resources via the network protocols. The requests can be generated by any application, either local or remote.

In a more generic implementation of the invention, the TrustCast™ Local Server is simply called the Translator, and the TrustCast™ Local Application is either a Custom Resource or any other local or remote resource. This Invention also covers the situation where the Translator has the additional responsibility of establishing the resource (e.g. delivering a file to either local or network storage) and/or customizing the hyperlink that provides access to the resource. In addition, the invention is designed so that the consultation of the security policy of the local machine and the security-policy of the network resources can be accommodated, so that the invention can enable access, while maintaining security.

In accordance with the invention, a computer-implemented local resource access system is provided. The system comprises an initiating program having an instruction that generates a request for access to a resource, the request including a token and having the form of a hyperlink. The system further comprises a translator program that receives the access, request from the initiating program wherein the translator program further comprises instructions that generate a return token in response to the access request and instruction that return the return token to the initiating program wherein the return token further comprises a hyperlink containing a path to the local resource.

In accordance with another aspect of the invention, a computer-implemented method for local resource access is provided. The method comprises the step of generating a request, by an initiating program, for access to a resource, the request including a token and having the form of a hyperlink. The method further comprises generating a return token, by a translator program, in response to the access request, and returning the return token to the initiating program, wherein the return token further comprising a hyperlink containing a path to the local resource.

### BRIEF DESCRIPTION OF THE DRAWINGS

FIG. 1 is a diagram illustrating a-common blocking problem encountered by a user presented with a web document containing a link to a local resource;

FIG. 1A is a diagram illustrating a common blocking problem encountered by a user presented with a web document containing a link to a local resource wherein the security is imposed outside of an application and the user of a TrustCast™ local application that allows a conditional solution to the blocking problem with respect to a security policy;

FIG. 1B is a diagram illustrating a common blocking problem encountered by a user presented with a web document containing a link to a local resource wherein the security is imposed outside of an application, and the use the combination of a TrustCast™ Local application and a TrustCast™ local server allows a conditional solution to the blocking problem while respecting the security policy;

FIG. 2 is a diagram illustrating an example of a method for executing a local resource in accordance with the invention using a media delivery system;

FIG. 2A is a diagram illustrating another example of a method for executing a local resource in accordance with the invention using a media delivery system;

FIGS. 2B1-2B8 is an example of computer code that implements a preferred embodiment of the format decision step;

FIG. 3 is a diagram illustrating another example of a method for executing a local resource in accordance with the invention using a media delivery system;

FIG. 4 illustrates another example of a method for executing a local resource in accordance with the invention using a media delivery system which incorporates security features;

FIG. 5 illustrates an example of a network attached storage (NAS) device being accessed using a local resource in accordance with the invention;

FIG. 6 illustrates an example of a web-page plug-in accessing a local resource in accordance with the invention;

FIG. 7 illustrates the data dependencies used within the method for generation of a link to a local resource in accordance with the invention;

FIG. 8 is a diagram illustrating a method for generating a link in accordance with the invention using an e-mail system;

FIG. 8A is a screenshot illustrating the user preferences for generating a link;

FIG. 9 is a diagram illustrating a method for generating a link in accordance with the invention using a messaging system;

FIG. 10 is a diagram illustrating a method for launching content in accordance with the invention;

FIGS. 10A1-10A4 is an example of data used to control the selection of a media player in a preferred embodiment of the media player selection step; and

FIGS. 10B1-10B10 are an example of the computer code that implements a preferred embodiment of the media player selection step, using the data shown in FIGS. 10A1-10A4.

### DETAILED DESCRIPTION OF A PREFERRED EMBODIMENT

The invention is particularly applicable to a media access system that may be used with the TrustCast™ media delivery system to access and execute a media file and it is in this context that the invention will be described. It will be appreciated, however, that the system and method in accordance with the invention has greater utility as it may be used with any system that delivers media to a user and it may also be used with any system which desirably wants to access local files without the security problems identified above. By virtue of using a Local Application to perform translation and dispatch, the Invention can also provide system level communication functionality beyond simple content access, in that arbitrary communications with both the operating system and other running processes may be accomplished. In the description below, the methods described are preferably implemented using one or more pieces of software code executing on one or more computing resources, such as personal computers, servers, workstations, PDAs and any other computing-device with sufficient computing resources.

The invention presented allows a software component or set of components to validate a hyperlink to a local (or remote) resource in the context of the network security environment and to securely allow that hyperlink to access local (or remote) resources without being subject to additional restrictions or user inconvenience. Additionally, the invention may provide faster response and lower overhead than previous methods. Additionally, the invention can allow security verification using the network layer when the computer is not connected to an external network. For example, users who rely on modems for connectivity are not required to dial in, and portable computers disconnected from their network function normally. Additionally, the invention allows documents or applications on a network (for example e-mail messages hosted on the World Wide Web) to hyperlink to local resources with higher security and lower user inconvenience.

The invention also includes the steps necessary to create the hyperlink, although this part of the system is by nature very dependent on the specific application of the invention.

A particular implementation of the invention, the TrustCast™ media delivery system, is presented which allows an email recipient to launch a pre-delivered media file with a single click from within an email program. The TrustCast™ media delivery system also allows access to predelivered media from both Web pages and from within messaging systems. While some email systems will allow this to be accomplished by using the HTML construct of file://filename within the email, others will generate a security warning or filter out such a link before it is ever presented to the recipient. Similarly, most messaging systems prohibit file://link types and most web browsers are configured with security zones that would prohibit an external web page from accessing local resources. The TrustCast™ system implements the invention described in this patent to avoid both security warnings, filtering and other processes that render simply sending a link in an email to file://filenaine either undesirable or non-functional. This implementation of the invention also maintains the overall security of the system, and implements a security protocol that allows the local user to have access to media, while assuring that the only media that is linked has been securely delivered and validated by the TrustCast™ system.

The invention as implemented in the TrustCast™ media delivery system, has been effective for all common email systems, including email applications which are local (e.g. Outlook, Eudora, Outlook express) or remote (e.g. Hotmail, Yahoo mail) or a combination (e.g. a local application that displays emails on a web page, such as AOL 6.0 or 7.0 mail), and for common messaging systems (e.g., AOL Instant Messanger), and for all common browsers (e.g., Internet Explorer 4.0 and above, Netscape 4.79 or better, Mozilla, Safari, etc.). The implementation entails a set of components, hereafter referred to as the TrustCast™ Local Server, and the TrustCast™ Local Application, that run at least partly on the recipient's computer and that communicate via both the local and network protocols. The TrustCast™ Local Server may or may not run locally and accepts requests for resources via the network protocols. The requests can be generated by any application, either local or remote.,

In a more generic implementation of the invention, the TrustCast™ Local Server is simply called the Translator, and the TrustCast™ Local Application is either a Custom Resource or any other local or remote resource. This Invention also covers the situation where the Translator has the additional responsibility of establishing the resource (e.g. delivering a file to either local or network storage) and/or customizing the hyperlink that provides access to the resource and/of facilitating the access to the resource by helping to select the correct handling application. In addition, the invention is designed so that the consultation of the security policy of the local machine and the security policy of the network resources can be accommodated, so that the invention can enable access, while maintaining security. Now, the invention will be more broadly described based on the figures. First, the content access problem solved by the present invention will be described in more detail.

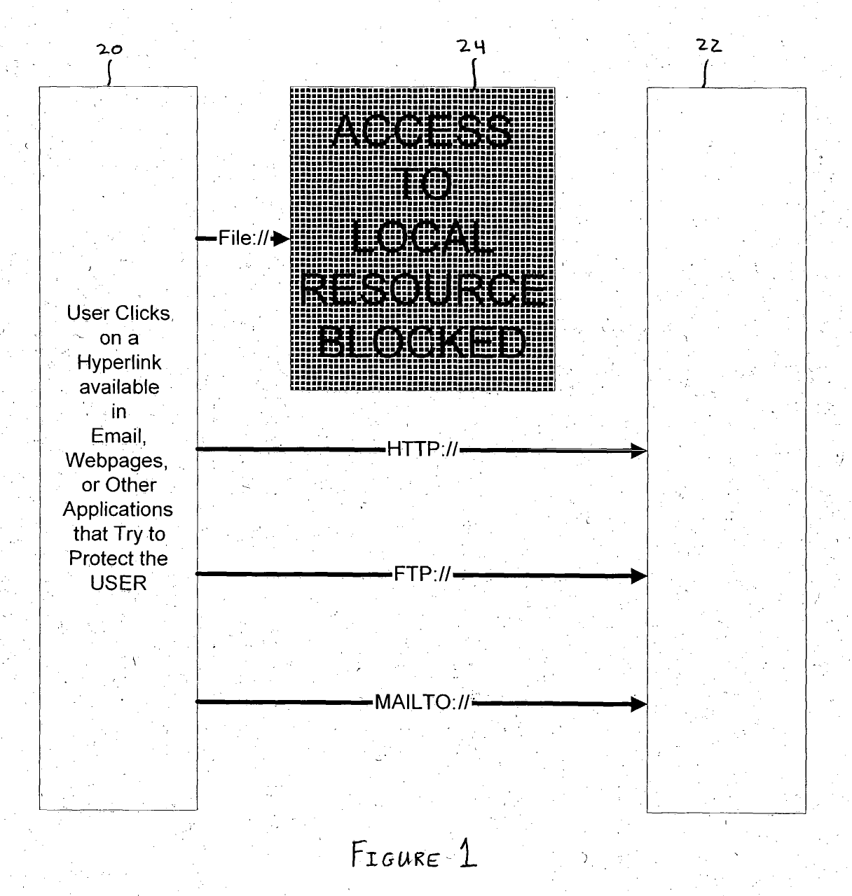

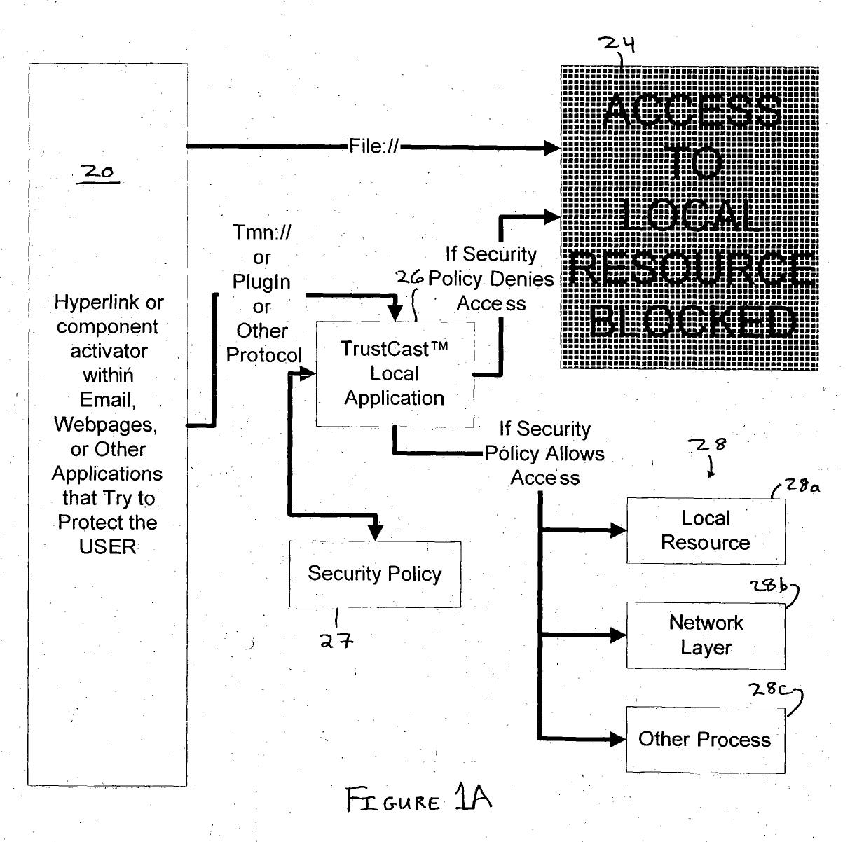

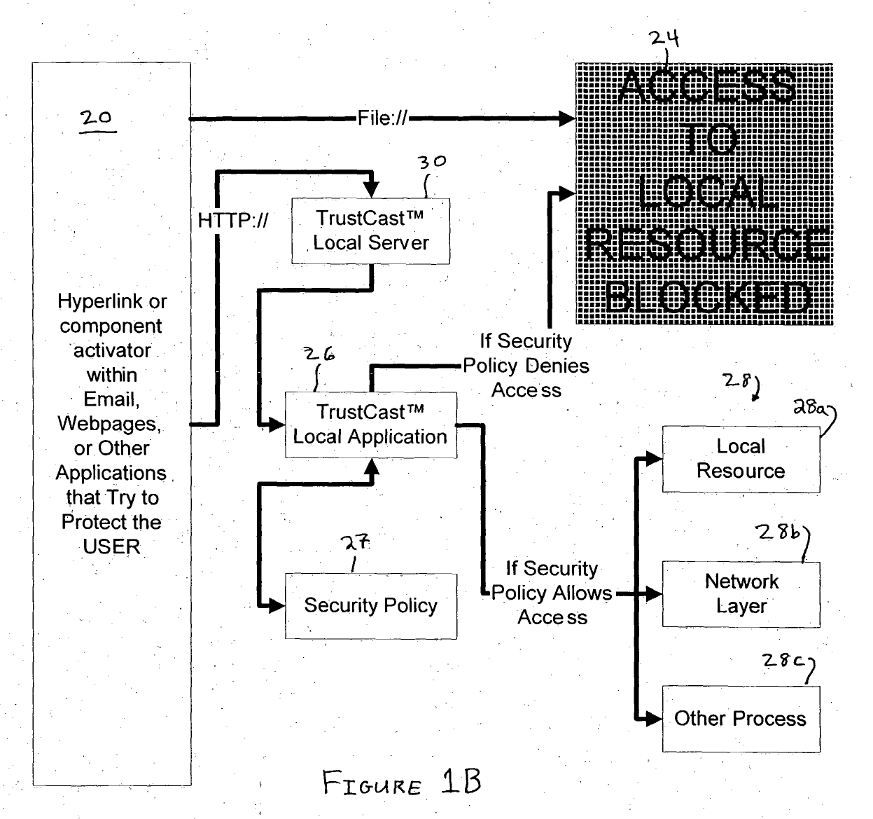

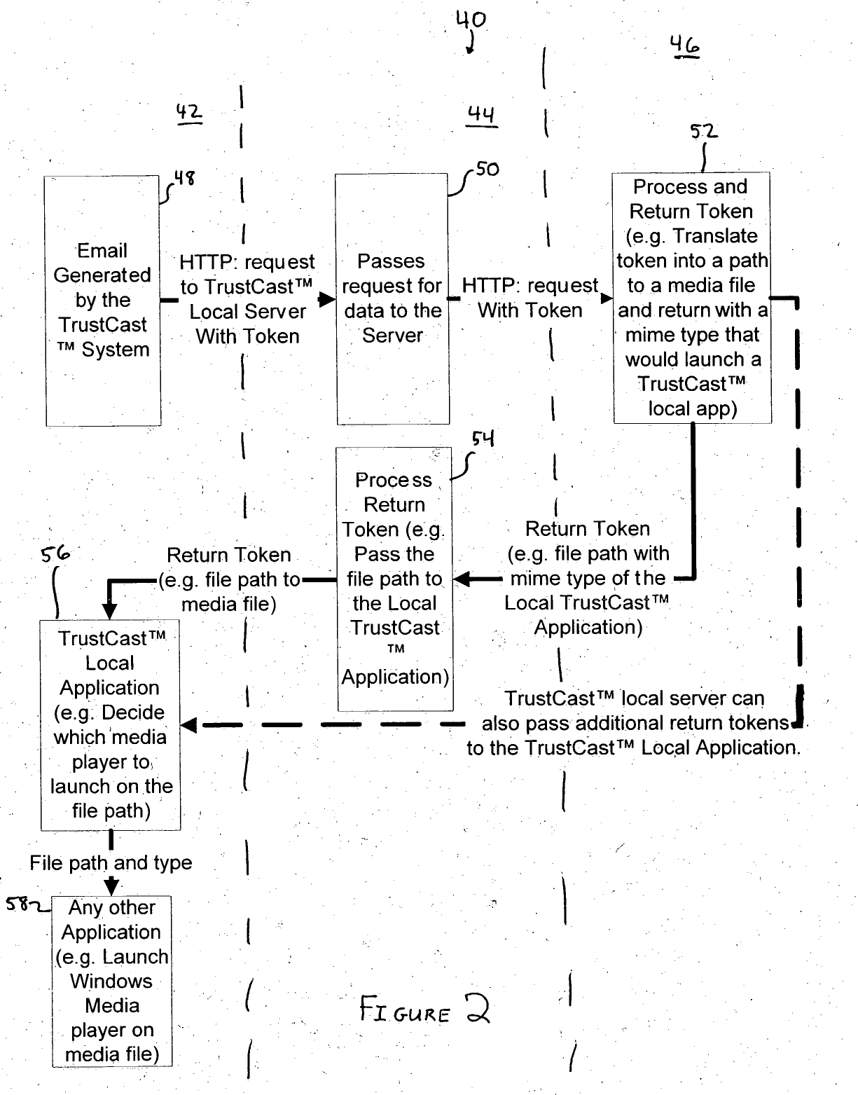

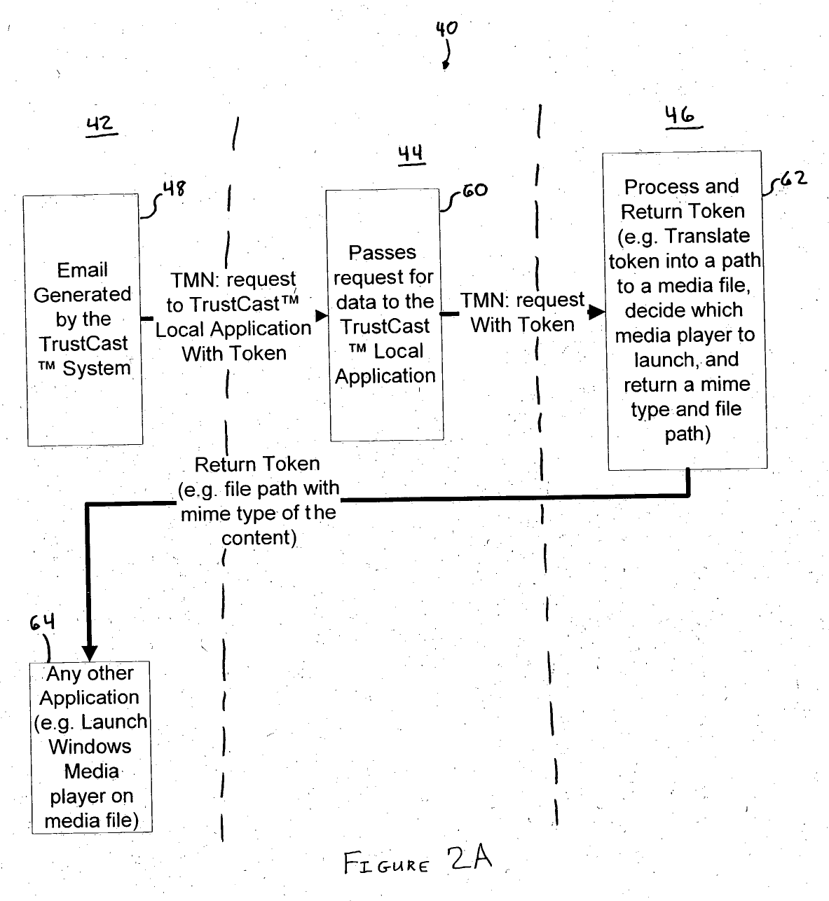

FIG. 1 is a diagram illustrating a common blocking problem encountered by a user presented with a web document containing a link to a local resource. In this diagram, a user driven local application 20, such as an email program, a plug-in application or a messaging application including short message system (SMS) or internet messaging system (IM), and a network layer 22 are shown wherein access to a local resource 24 is blocked by the network layer. The network layer is well known and will not be described further herein. In more detail, FIG. 1 illustrates what can commonly happen when a user is presented with a web document that contains a link to a local resource using the method of file://localfile. The user desires to access the local resource, such as a piece of media or content, by clicking on the link presented to them via various delivery systems, such as e-mail, web pages or other applications. However, due to security concerns, the user is prevented from accessing (or blocked from accessing) the local resource. This blocking of the local resource is not always insurmountable, such as in a local application that responds to a user clicking on a link by putting up a security dialog that asks if the user wishes to proceed with a possibly unsafe action. In other cases, the link may be much more difficult to execute, such as in a web-based email program that automatically filters out such a link unless the user performs a highly sophisticated combination of actions for each message. Due to security concerns, there are also some aggressive email programs that will irretrievably remove such a link—in which case it will never be presented to the recipient. The invention described below permits the user to access the local resource with the problems/limitations that are imposed by current systems. Now, another example of the blocking problem that is solved by the invention will be described.

FIG. 1A is a diagram illustrating a common blocking problem encountered by a user presented with a web document containing a link to a local resource, as described in FIG. 1, and the solution of this blocking problem through the use of the TrustCast™ Local Application in where an external security policy is consulted outside of the application. In this example, the user driven local application 20 communicates with a second local application 26, such as a TrustCast application described in more detail in the co-pending application incorporated by reference above, but access to the local resource 24 is still blocked by the network layer. In this example, the second local application 26 may, in conjunction with a security policy 27, access a local device 28, such as a local resource 28a, a network layer 28b or other processes 28c. In this example, the local user-driven application 20 contains a hyperlink or component activator within a delivery system, such as an email, web page or other application, wherein, the delivery system attempts to protect the user by blocking access to the local resource. In this example, the user-driven local application 20 accesses a link, such as Tmn:// or a plug-in other protocols, which results in the activation of the second local application 26 as shown. Now, another example of the common blocking problem that is solved by the invention will be described.

FIG. 1B is a diagram illustrating a common blocking problem encountered by a user presented with a web document containing a link to a local resource, as described in FIG. 1, and the solution of this blocking problem through the use of the TrustCast™ Local Application in conjunction with a TrustCast™ Local Server, where an externals security policy is consulted outside of the application. In this example, access to the local resource is again blocked which inconveniences the user. In this example, the user driven local application 20 generates a hyperlink or component activator (such as HTTP:// example shown) within a delivery system, such as an email, webpage or other application, which is targeted to the local server 30. The Local server 30, tan then either reflect or otherwise transmit this request to the TrustCast™ Local Application 26, which can operate as described in FIG. 1A. Now, the invention, that overcomes the above local resource blocking problem, will be described in more detail.

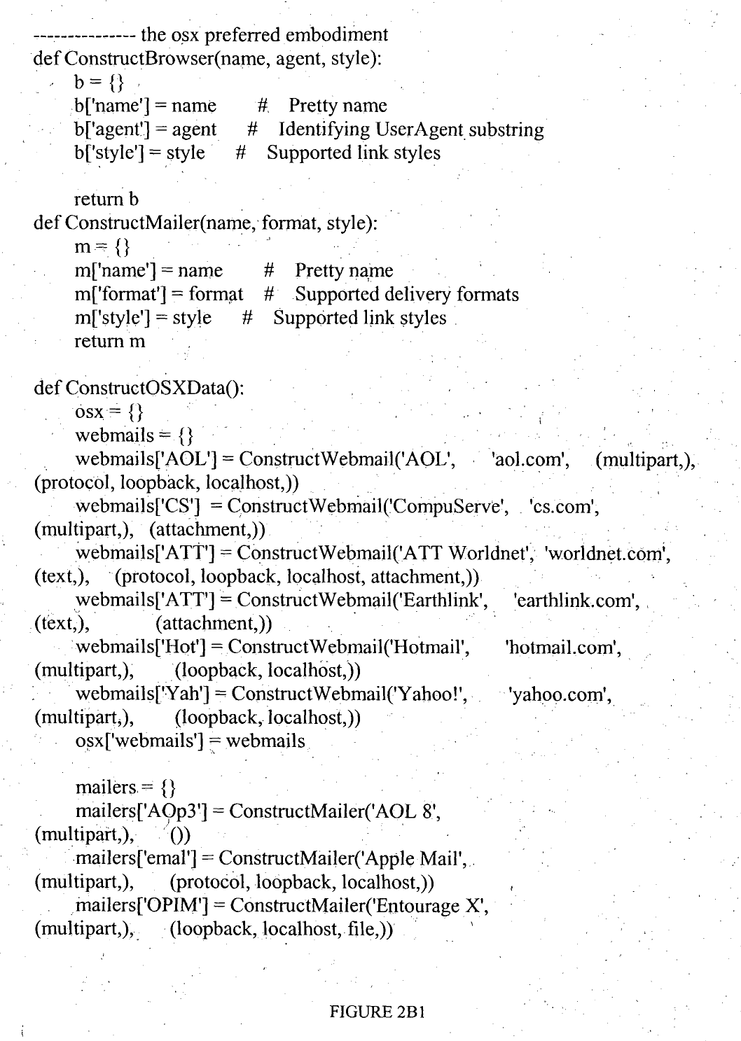

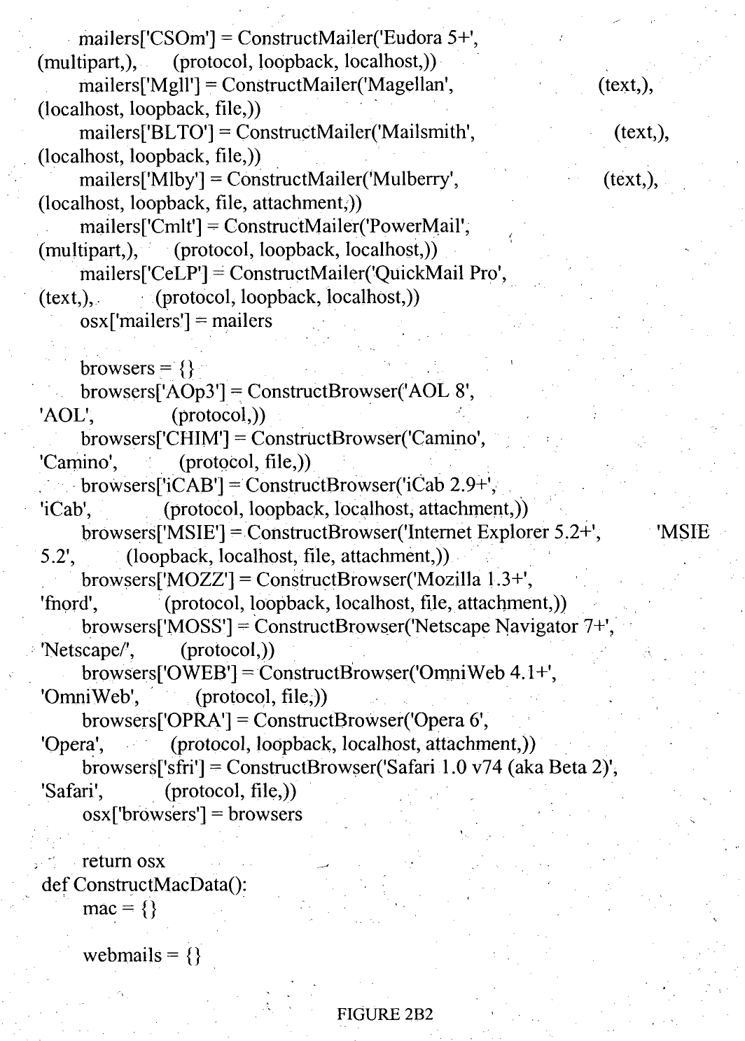

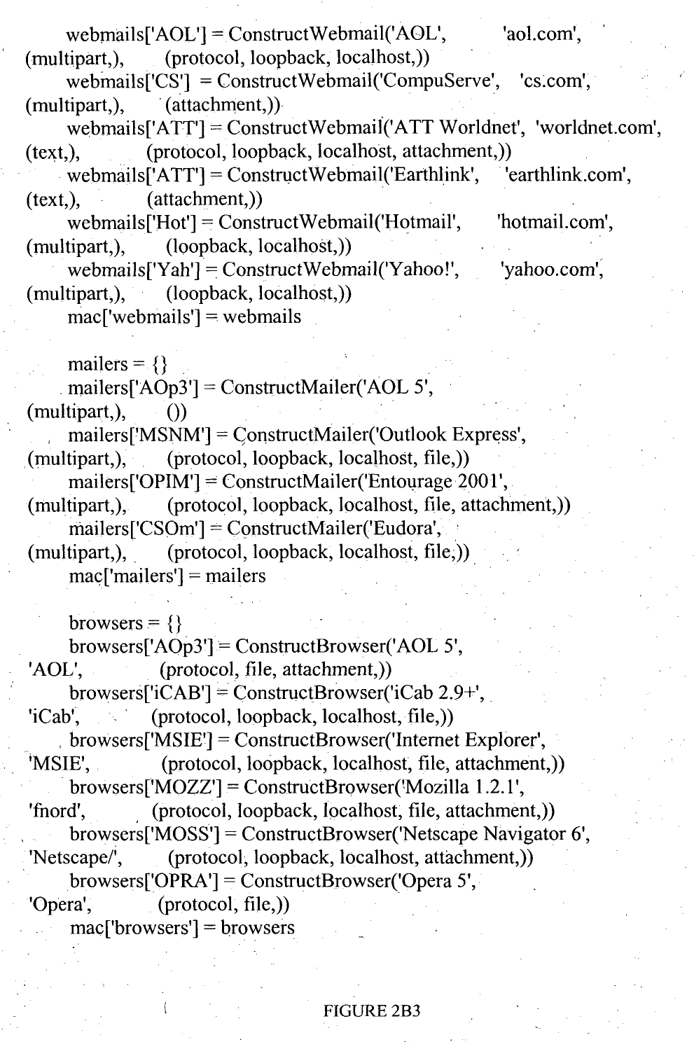

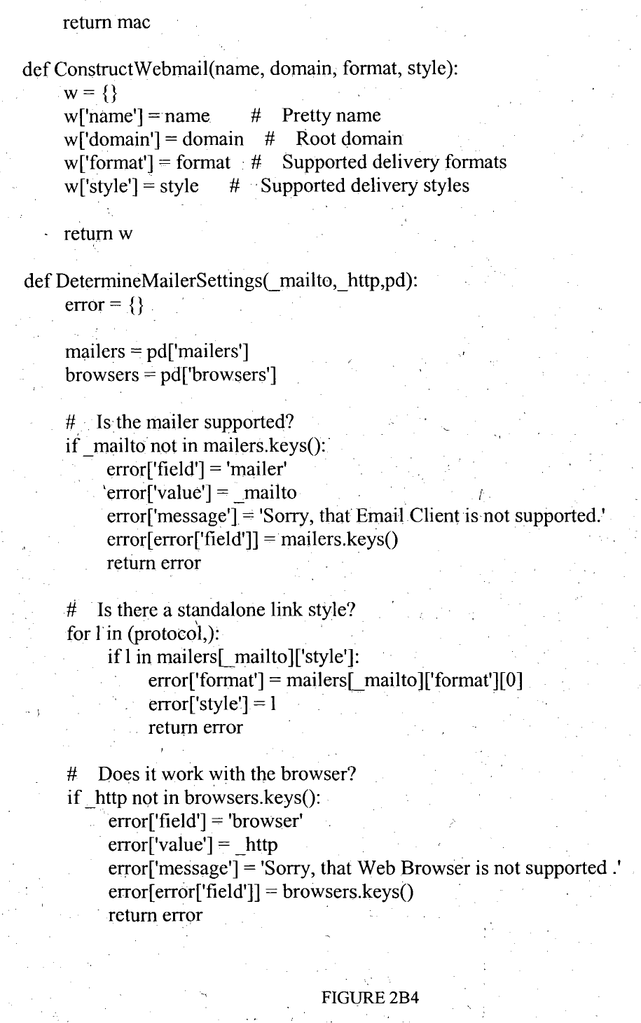

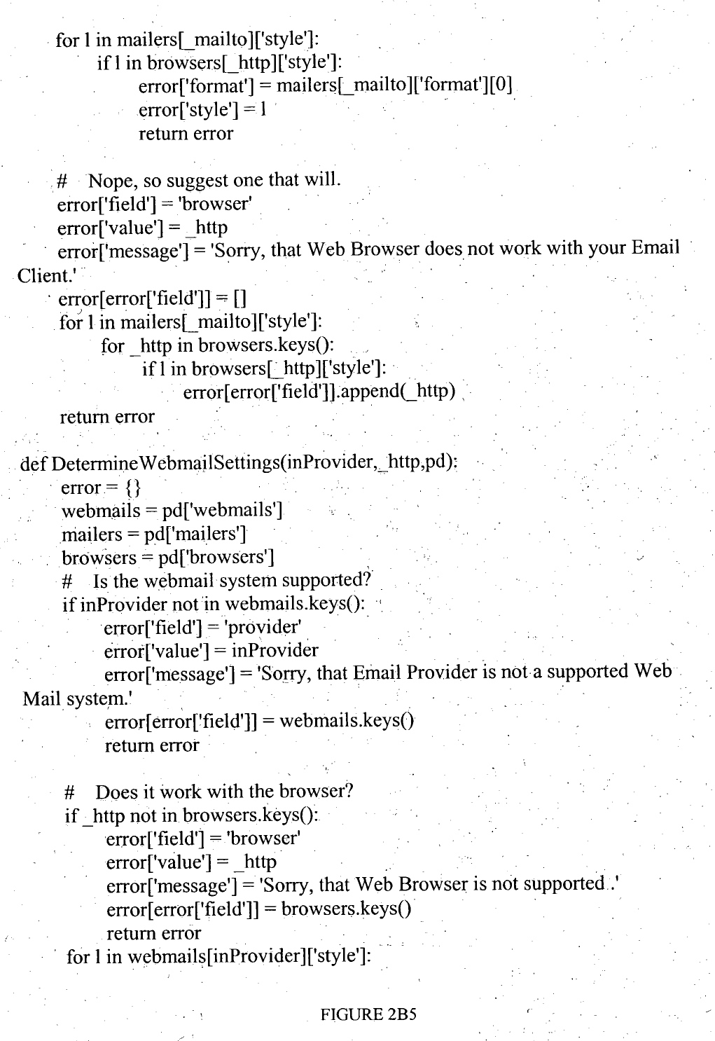

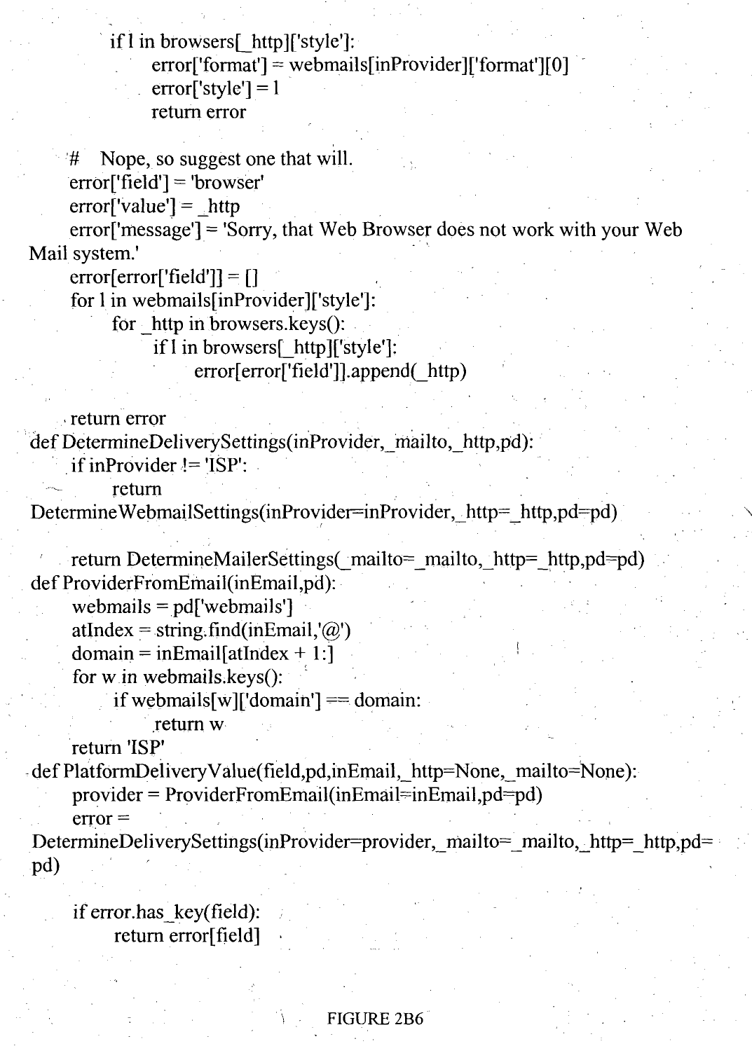

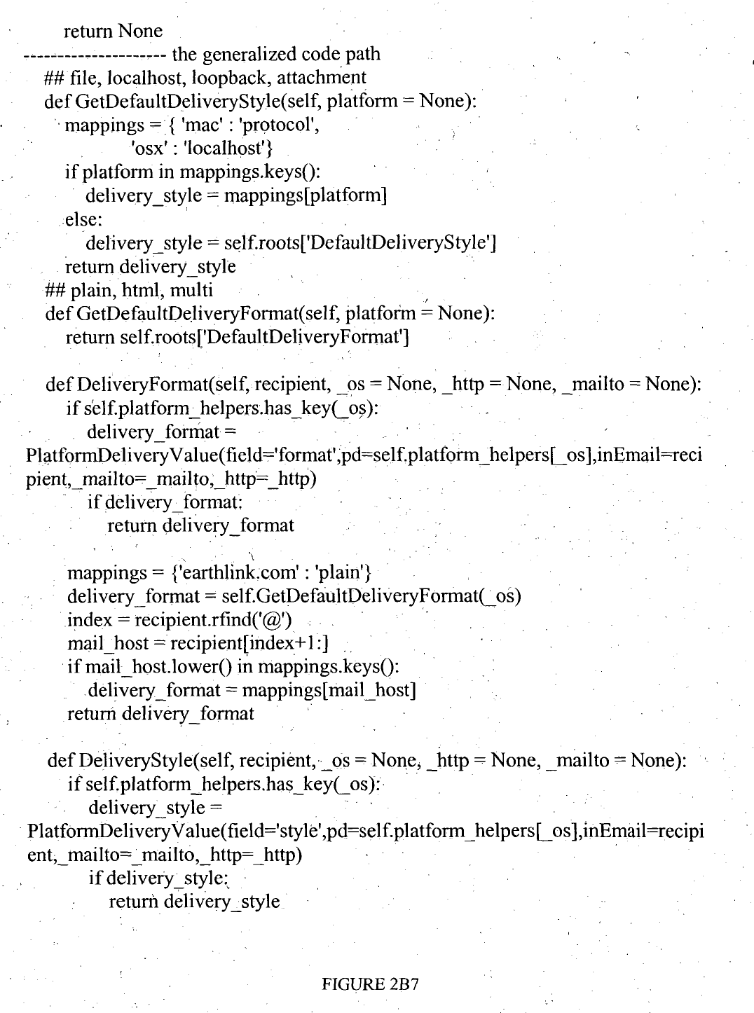

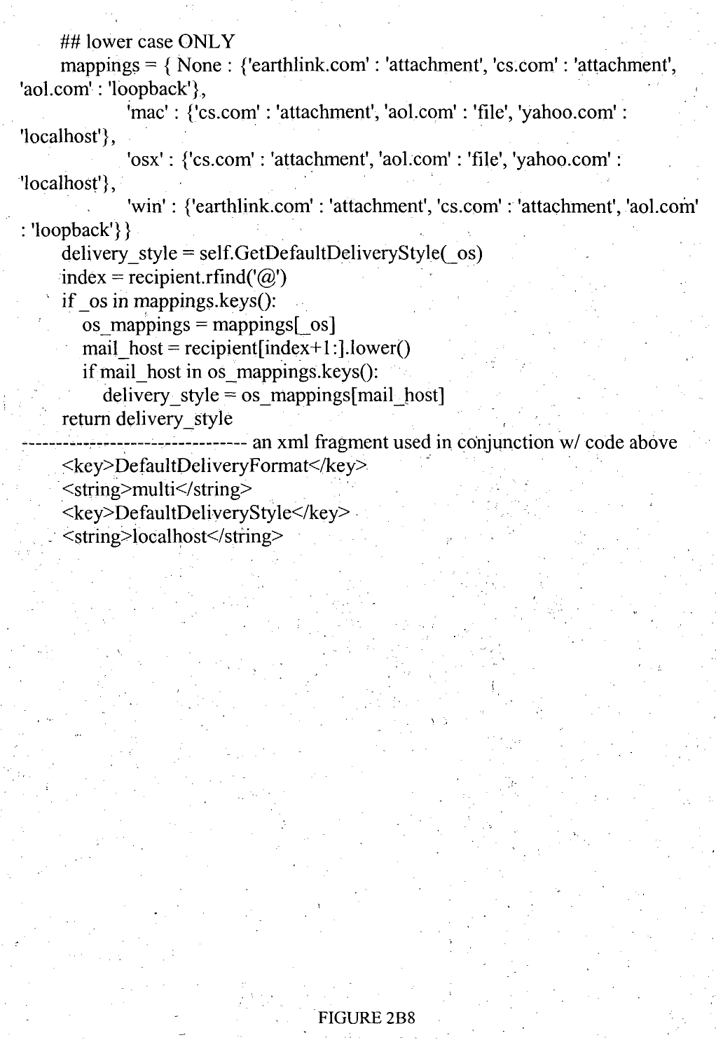

FIG. 2 is a diagram illustrating an example of a method 40 for executing a local resource in accordance with the invention using a media delivery system. In the diagram, the steps associated with a local user driven application 42, the steps associated with a network layer 44 and the steps associated with a local server 46 are shown. In this example, the local server is a TrustCast local server which may be, for example, executed on a local computer resource. In more detail, FIG. 2 illustrates the invention that enables the playback of content in the TrustCast™ media delivery system described in the co-pending patent application which was incorporated above by reference. Generally, the process 40 shown covers the steps from a user clicking on a link in an email generated by the TrustCast™ delivery system, and ends with a desired local media file being played for the user. The local resource accessing system enables that method by permitting access to the local resource without blocking access to the local resource. In this example, the local resource request is made with an HTTP link with an 15′ embedded token that is directed to the local server.

As shown in FIG. 2, the method begins as the TrustCast™ delivery system generates an email (step 48) containing an http link, which most applications will pass without any security, warning or restriction to the local machines network layer. An example of software code that may be preferably used to generate the messaging system, links, such as an e-mail hyperlink in the example, is shown in FIGS. 2B1-2B8. When the link is clicked by the user, an http link is sent to the network layer with a token which identifies the particular local resource, such as a particular piece of media or content, that is to be retrieved by the link. The network layer 44 can then pass the http request on to the TrustCast™ Local Server (step 50). In the example of the TrustCast delivery system shown in FIG. 2, the TrustCast™ Local Server 46 is a local web server that listens for requests on a specific port and passes back, through the recipient computers network layer, a variant of the tokens that are passed to it with a mime type that will launch the TrustCast™ Local Application (step 52).

The security in the system is implemented by either restricting this web server to only respond to requests that originate on the local machine and/or by only allowing the returned tokens to contain paths that lead to media content in a certain set of directories. Additional security could be implemented by replacing paths with a numeric value that references a Look-Up-Table (LUT) wherein the LUT could be securely delivered using standardized protocols. Thus, in step 54, the token is returned (e.g., a file path with a mime type of the local application 44) and, the local application processes the return token (e.g., passes the file path to the local application). The TrustCast™ Local Application in turns uses the tokens to decide which local application (e.g. media player) to launch and on what local file. Note that the TrustCast™ Local Server could also be implemented to perform additional actions in response to the http requests it receives—one possibility for such an action would be the passing of information directly to the TrustCast™ Local Application. For example, as shown in the diagram, in step 56, the local user driven application 44 receives the return token (the file path to the media file) and the decodes the file path to determine which media player to launch on the file path. In step 58, using the file, path and type information, the media player is launched with the media file pointed to by the return token. In this manner, the local resource (the local media file in this example) is accessed and executed in accordance with the invention. Now, another example of a method for executing a local resource in accordance with the invention will be described.

FIG. 2A is a diagram illustrating another example of a method for executing a local resource in accordance with the invention using a media delivery system. As with FIG. 2, in step 48, the local user driven application 42 generates a local resource request (in the form of an e-mail.) In this example, the local resource request is a TMN link/request to the local application 44 with a token (whereas in FIG. 2, the request was directed to the local server.) In step 60, the ′request is passed to the local application 46. In step 62, the local application 46 processes the returns: the token by performing one or more actions, such as 1) translating the token into a path to the media file; 2) deciding which media player to launch to play the media file; and 3) return the mime type and file path to the local user driven application 42 as shown. In step 64, the user driven local: application launches any, other application (such as launching the Windows Media Player using the media file pointed to by the file path.) FIGS. 2B1-2B8 are an example of the computer code that may be used to implement the preferred embodiment of the email link generation step described above. Now, another example of a method for executing a local resource in accordance with the invention will be described.

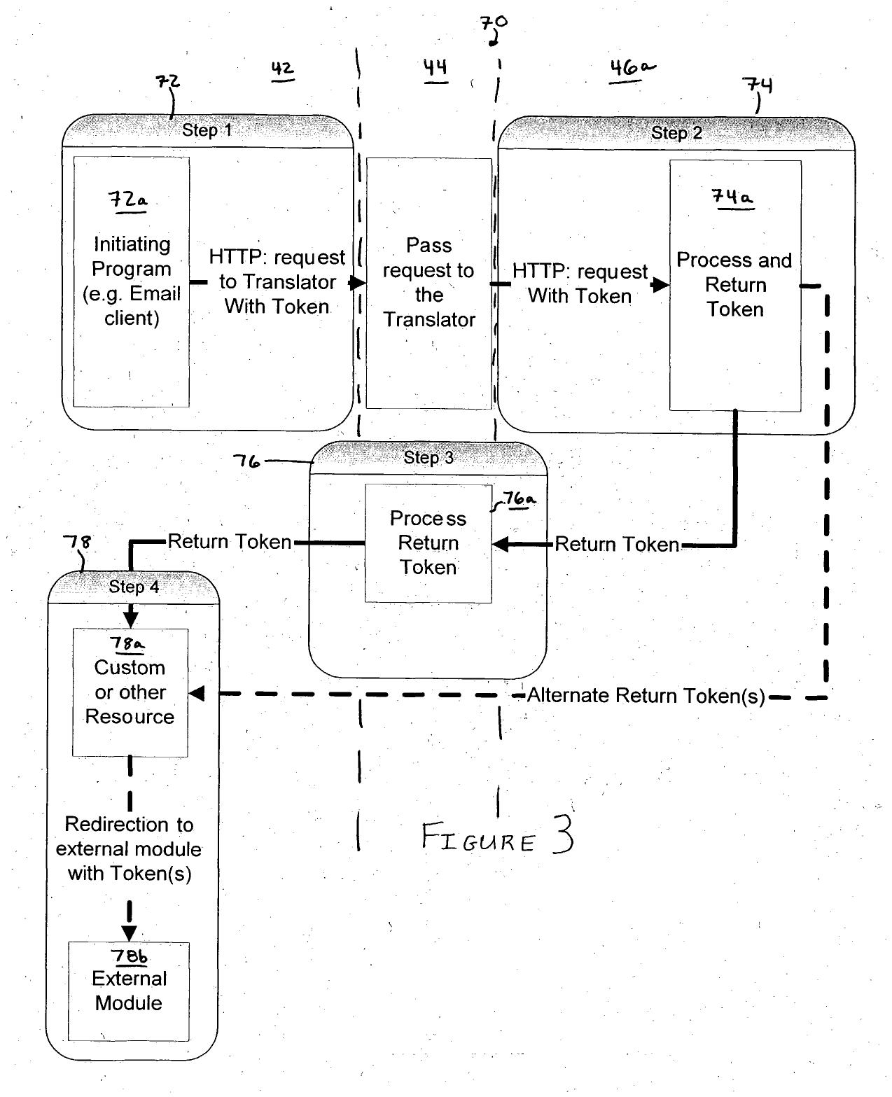

FIG. 3 is a diagram illustrating another example of a method 70 for executing a local resource in accordance with the invention using a media delivery system. This diagram illustrates the more generally applicable method for local resource execution in accordance with the invention. As with FIG. 2, the user driven local application 42 actions, the communications/network layer 44 actions and a request translator 46a actions are shown at the top diagram to better understand which actors performs which actions in the method. The request translator 46a is an element that receives the local resource request translates it into a file path (such as the local server or local application 46 shown in FIGS. 2 and 2A), and the request translator may also be other hardware devices or software devices that perform the desired function. The request translator 46a may or may not be physically located on the same computing resource as the local application. Broadly, the method 70 comprises a request step 72, a token processing step 74, a return token step 76 and an execute local resource step 78 wherein each one of which is a step in the process that translates an http request (in this example) into access to a local resource. The invention is composed of both the Translator, the Custom Resource and the overall process represented by the four steps in diagram, which in combination act to enable access to either the Custom Resource or the local resource.

During the request step 72, a requesting software application 72a (an email client is this, example) generates a request (an HTTP request in this example) with a token communicated through the network layer to the Translator 46a. Because this request uses the network layer 44; it is not subject to some or all of the restrictions placed on local accesses. In accordance with the invention, the request contains a token or set of tokens identifying the desired resource and action. For example, each token can be a path name, a partial path name, a resource locator containing path-like information and additional arguments, or a numeric or alphanumeric token which may be used as a key to look up additional information maintained in a data table. An example of the Http Request with Token would be

http://localhost:27239/index.tmn?file=/Digital%20Kitchen/Nike%20Braind%20The atre%20-%20Chapter%203/Nike_{—}3-1.wmv&type=.tmn

The returned Token is a file index.tmn whose body contains the text

index.tmn?file=/Digital%20Kitchen/Nike%20Brand%20Theatre%20-%20Chapter%203/Nike_{—}3-1.wmv&type=.tmn

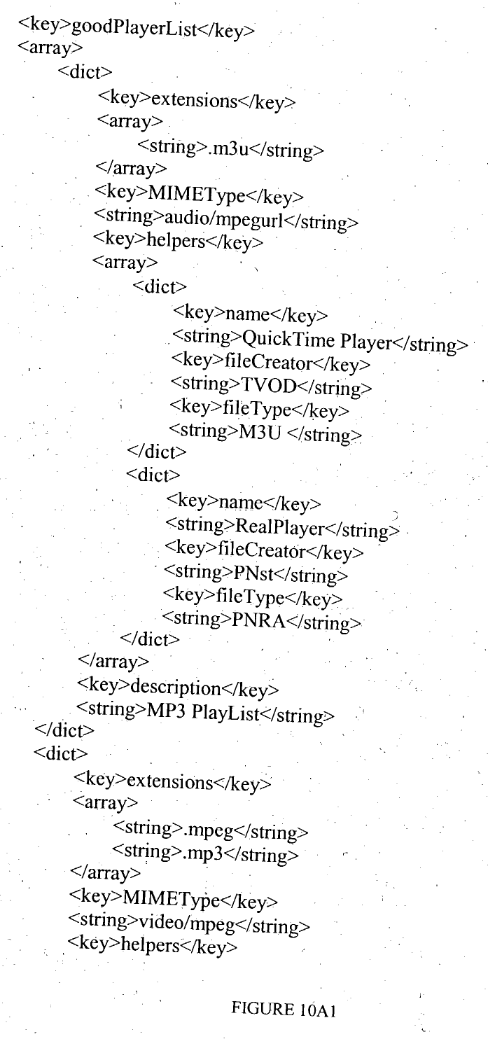

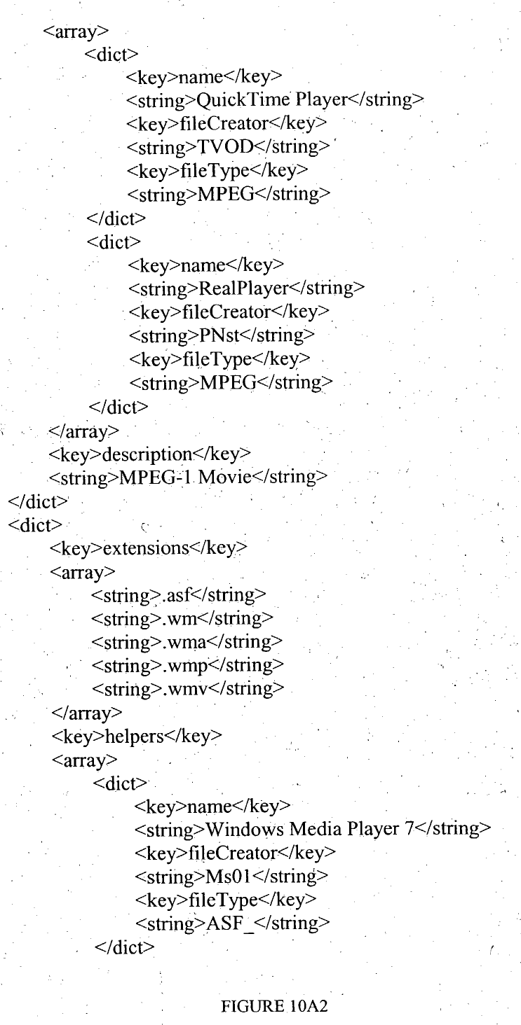

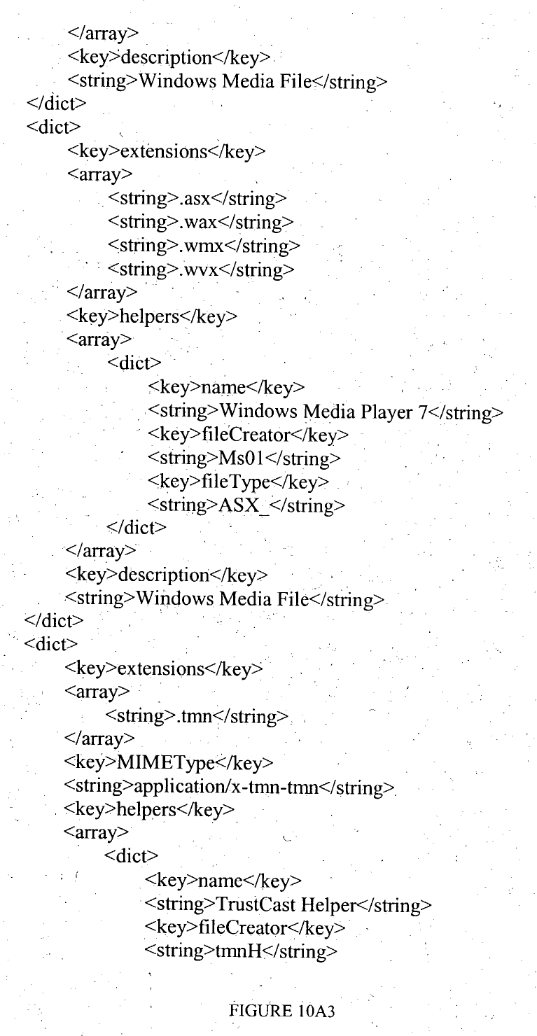

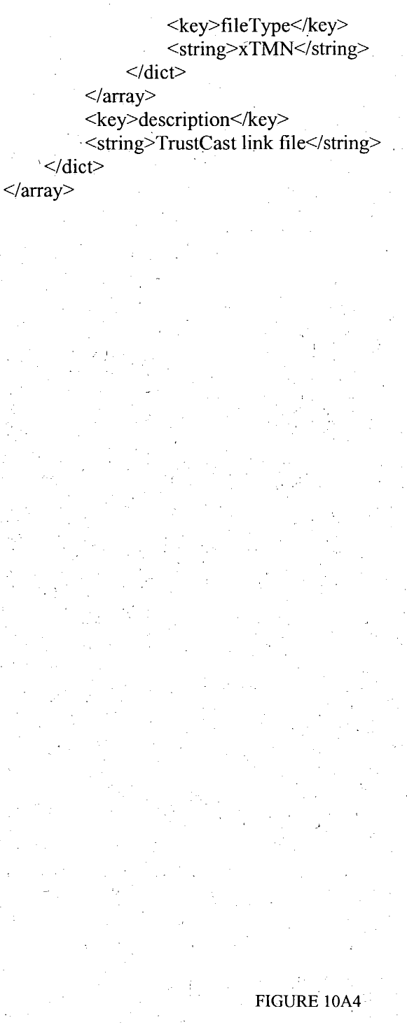

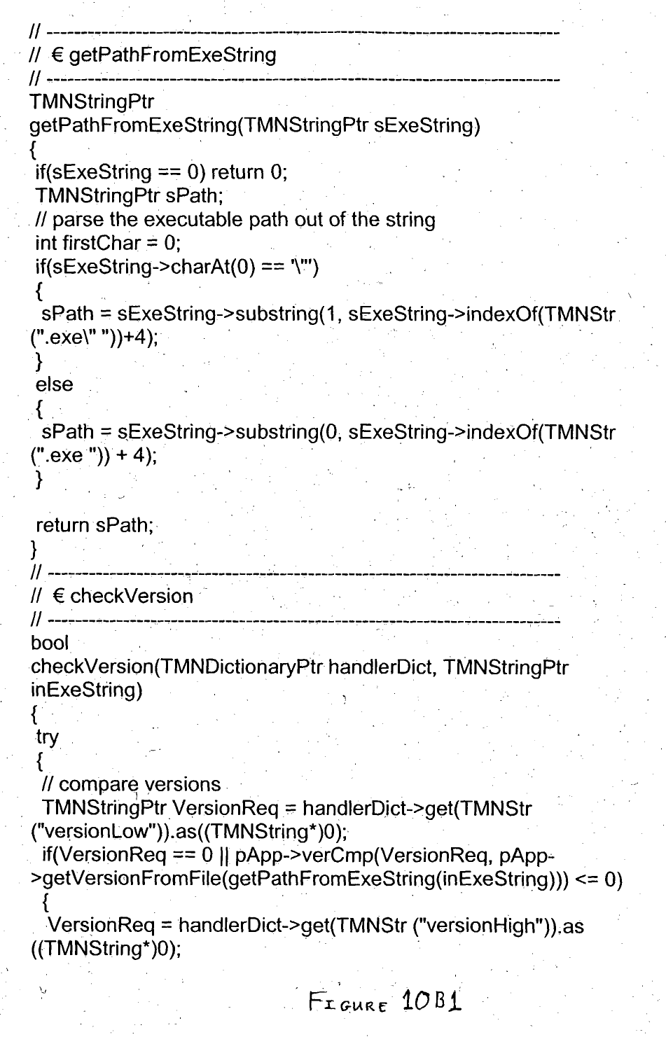

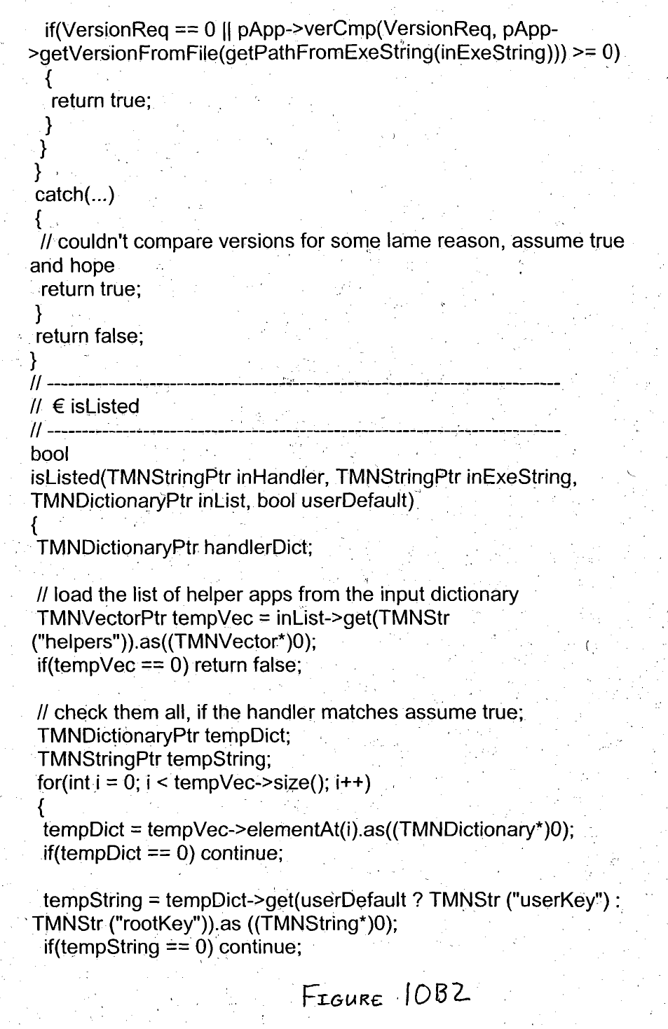

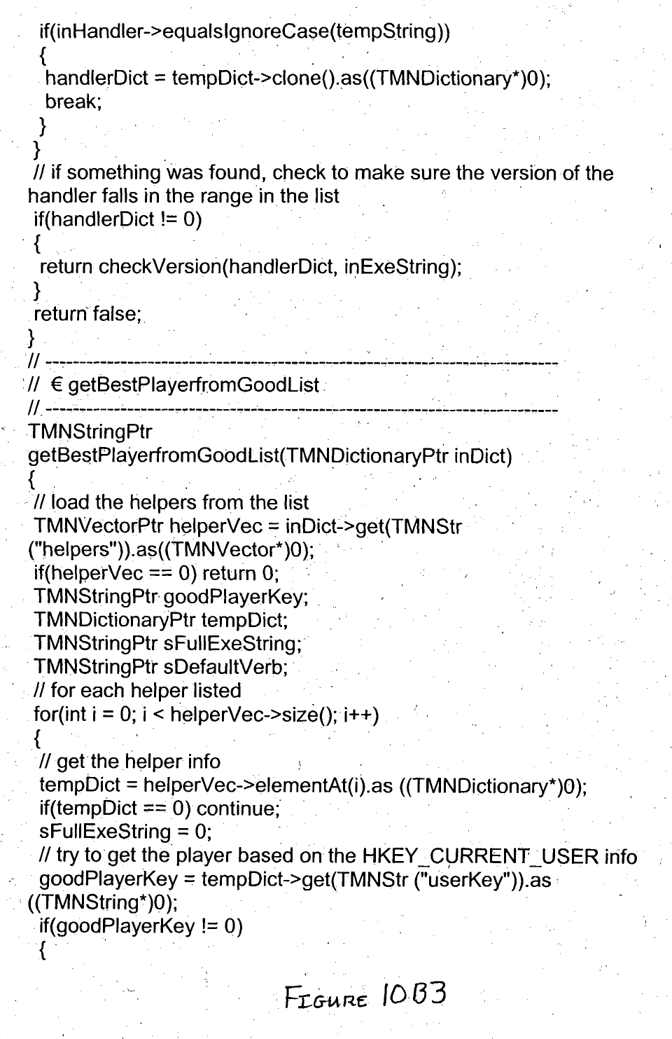

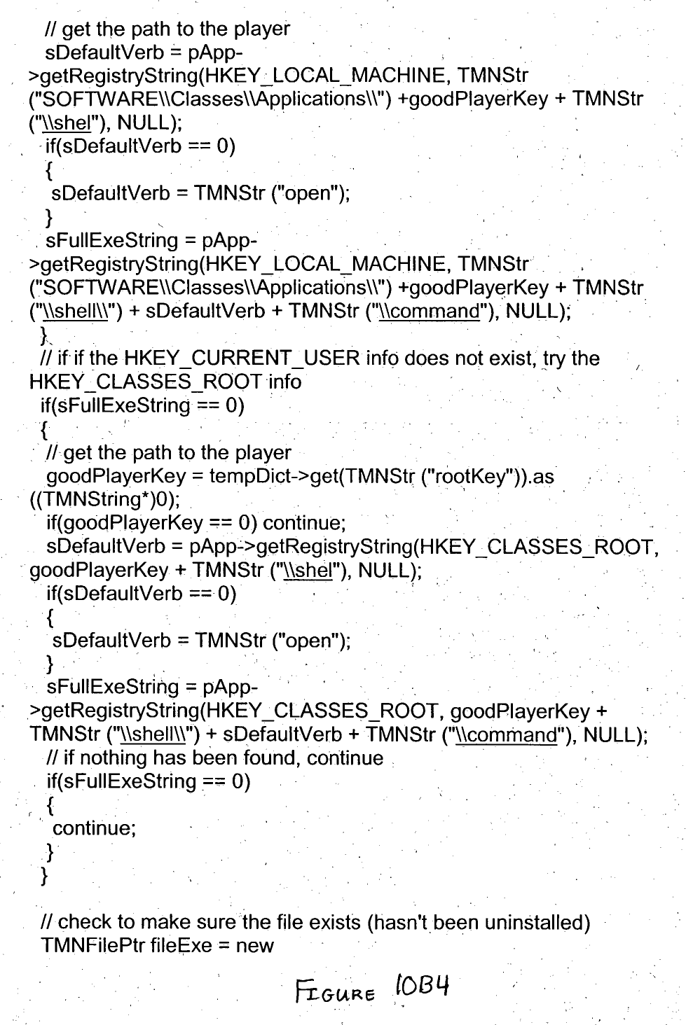

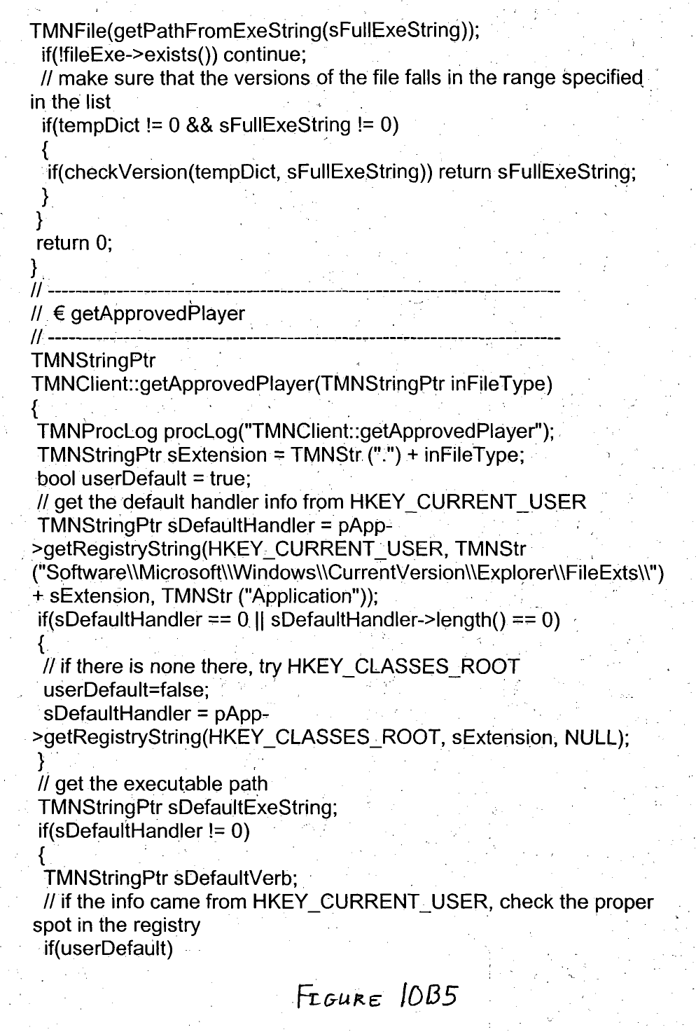

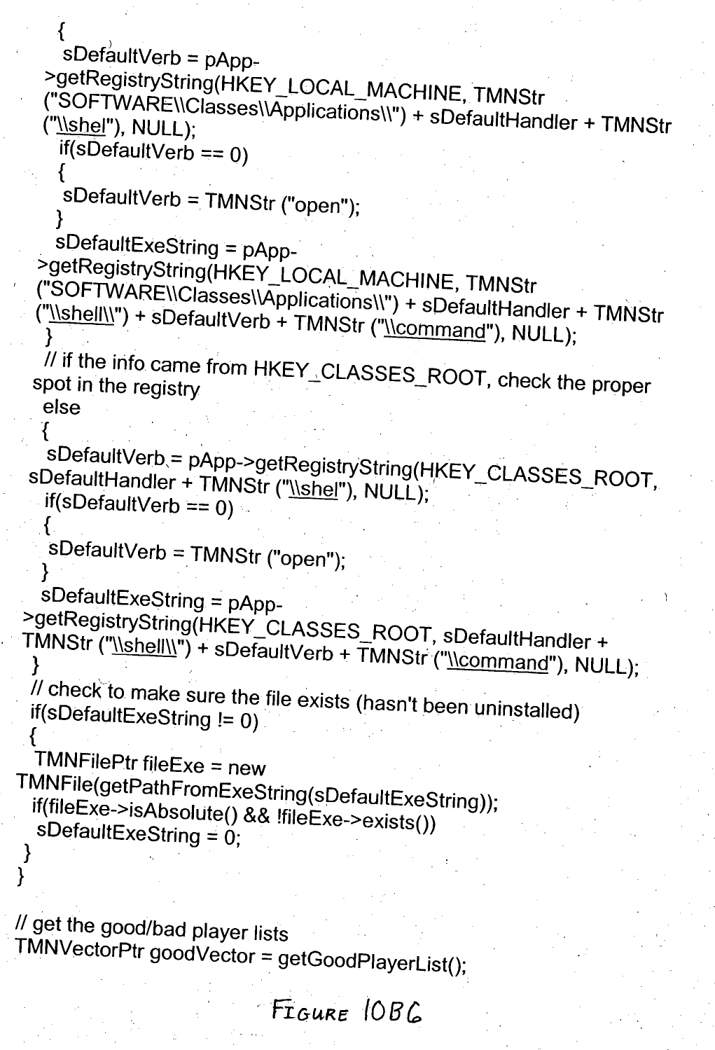

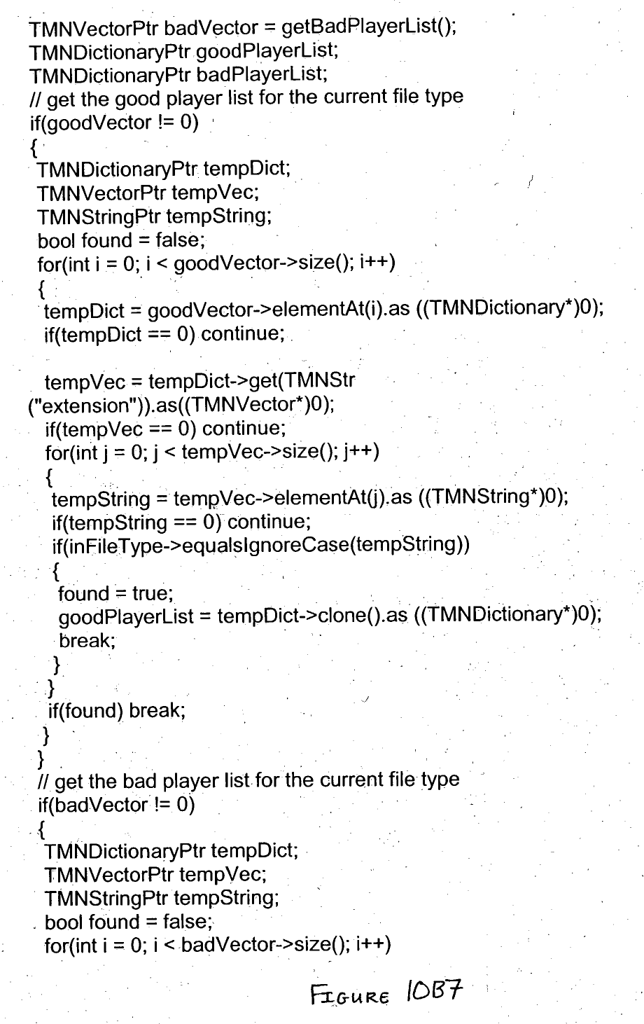

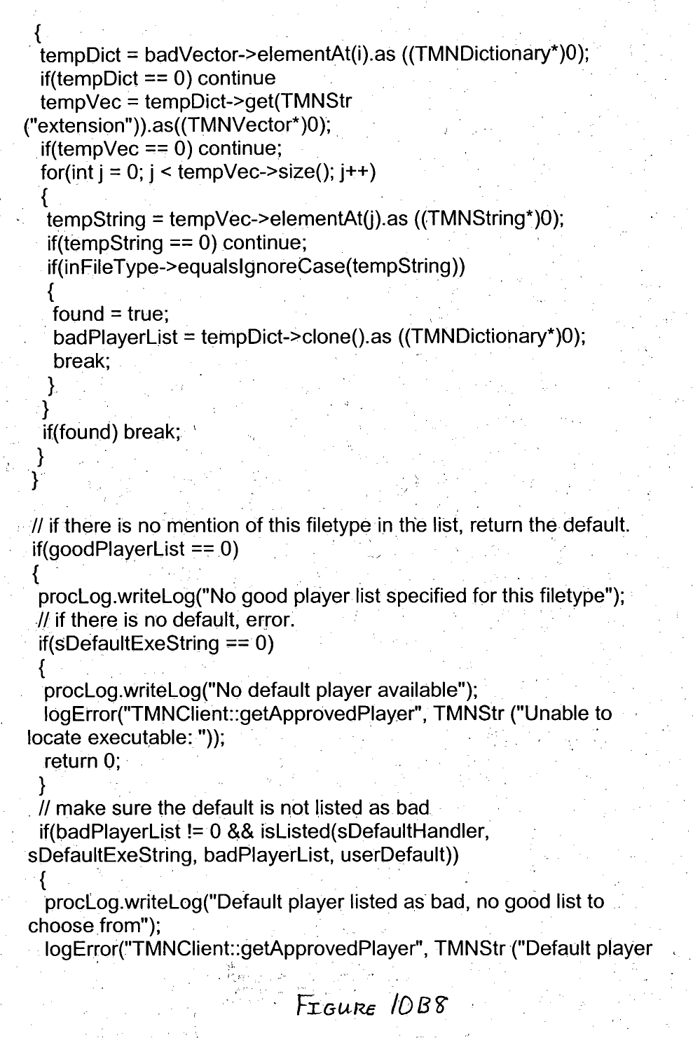

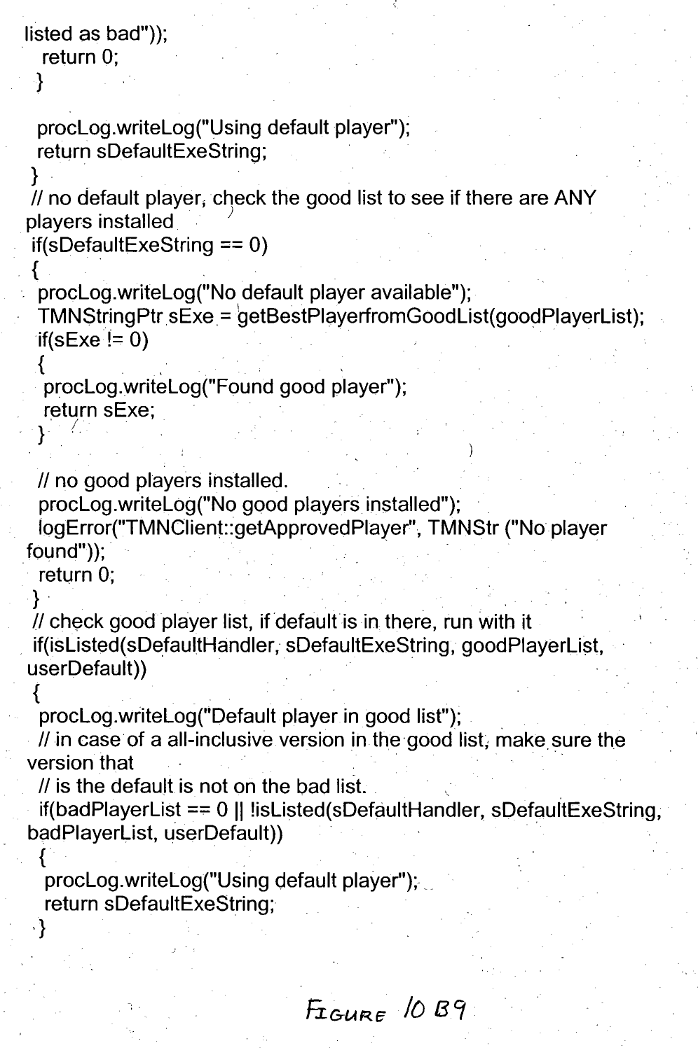

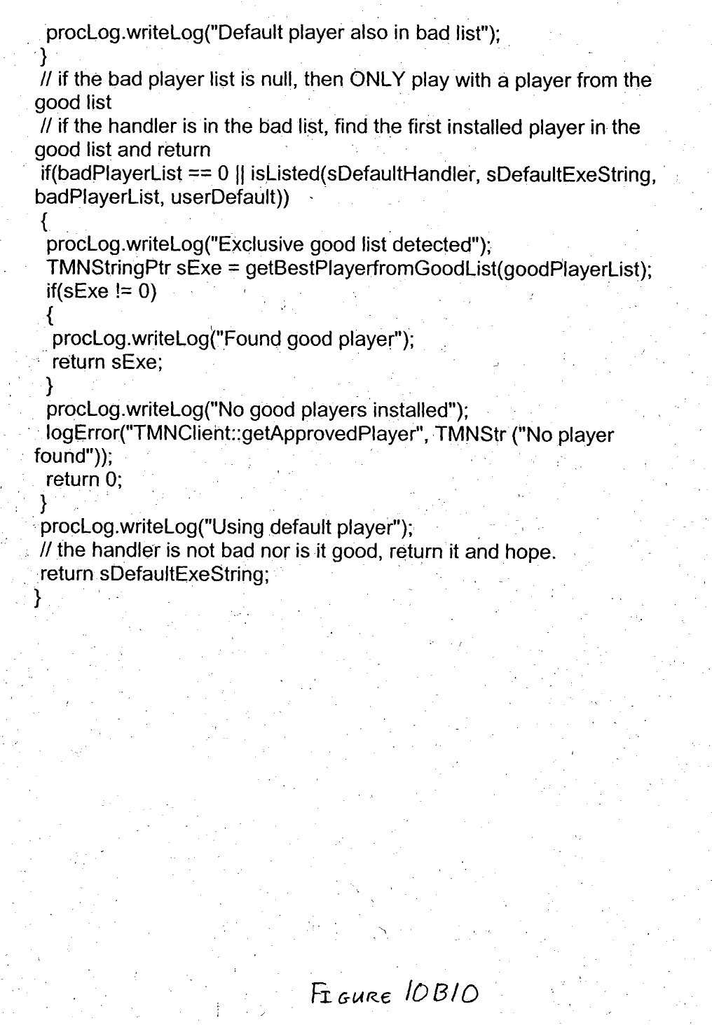

This file is then passed to the TrustCast™ local application which translates the Token into a full path and passes the path to a compatible local application (as described in FIG. 10).

During the token processing step 74, the Translator 46a receives the request with the token, processes the request and token and responds to the request with a return token set (step 74a). The return token set, for example, may duplicate all or part of the request tokens and/or contain other information determined by the request token set. The return token set is used by the requesting application to locate and access either the Custom Resource or the local resource. Optionally, the Translator 46a may generate or modify the Custom Resource prior to returning the result token set. This allows for just-in-time creation or updating of the information and resources. During the return token step 76, based on attributes of the information returned, the requester directs the return token set (in step 76a) to either a Custom Resource or to any local resource 78a. The attributes determining the action may include tokens as previously described, which may relate to commonly used descriptive elements such as file extension, Internet MIME types, header values, or unique identifiers used to indicate information classes. The Custom Resource may be a tightly integrated with the Translator, or an external component whose actions can be directed through data tokens or software application programming interfaces (APIs).

During the execute local resource step 78, the Custom Resource may access local resources directly 78a, or the Custom Resource may direct an external module 78b resident on the same computer to access local resources. This external module may be a software component that is otherwise restricted from accessing local resources described in a networked document. This access may occur via the local file system or local resource access protocols, or a combination of local and network protocols. Now, another method for accessing local resources in accordance with the invention will be described.

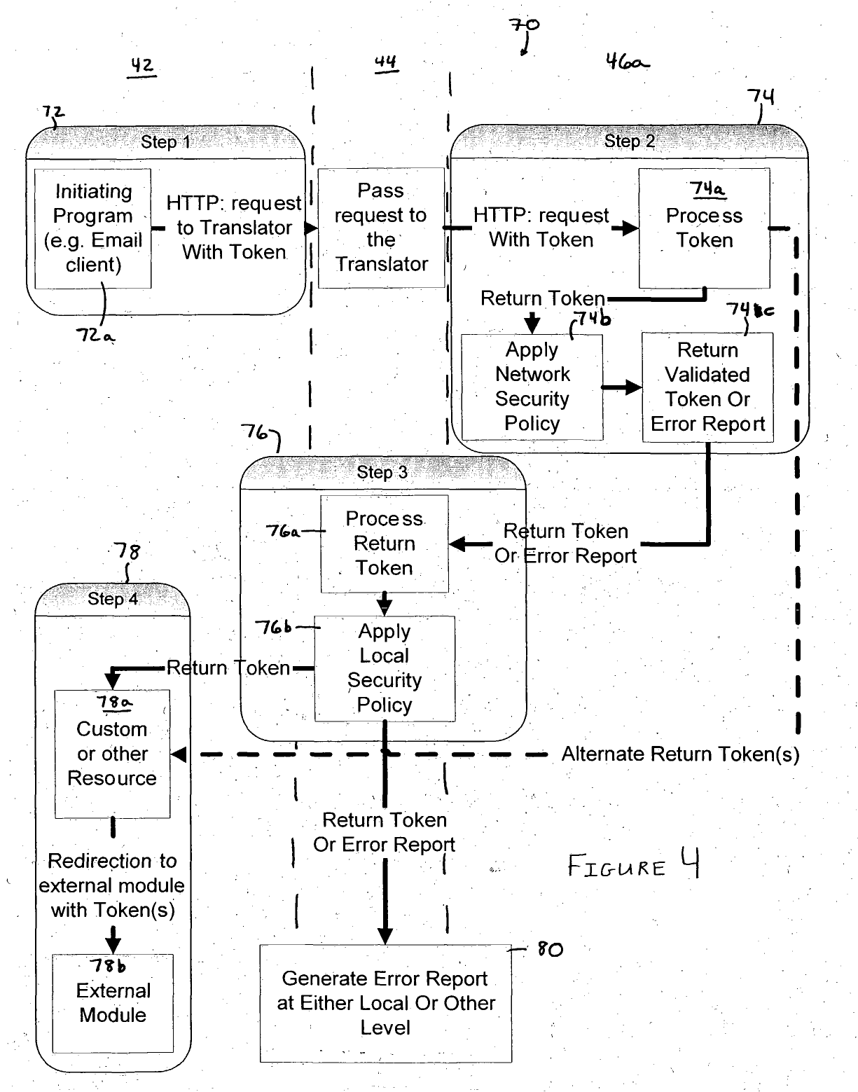

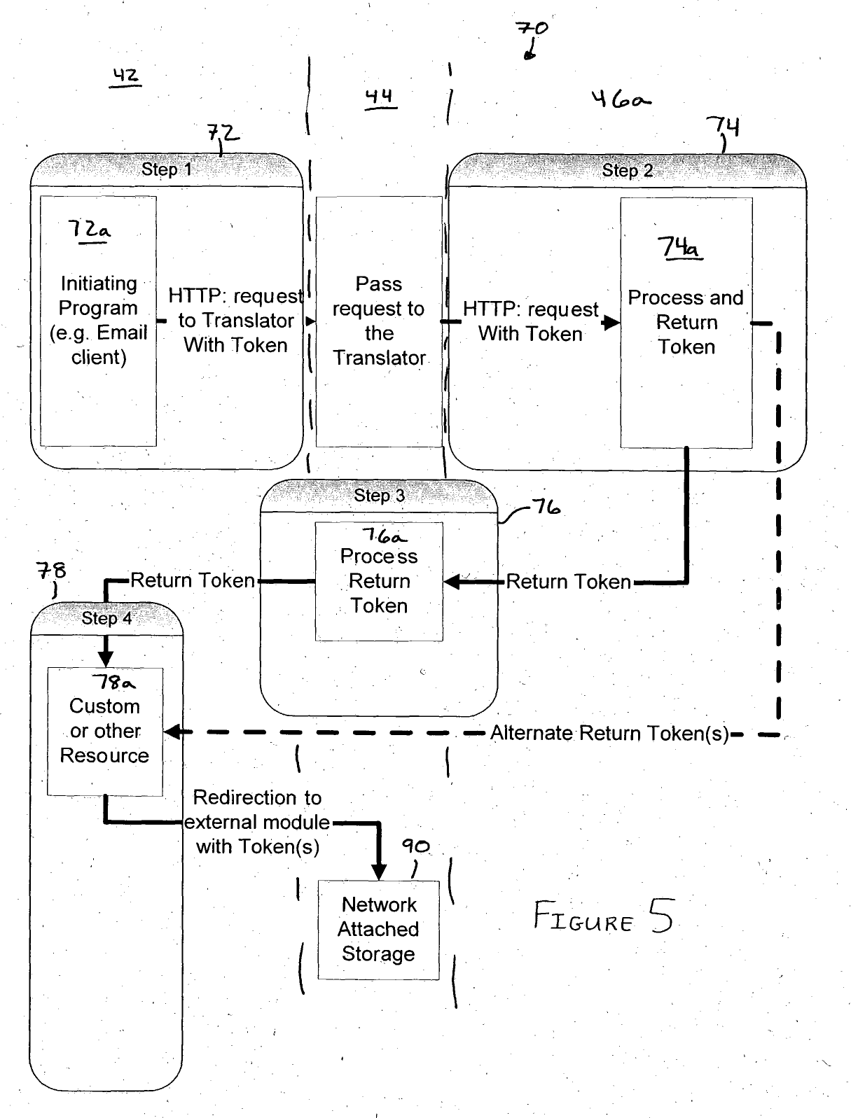

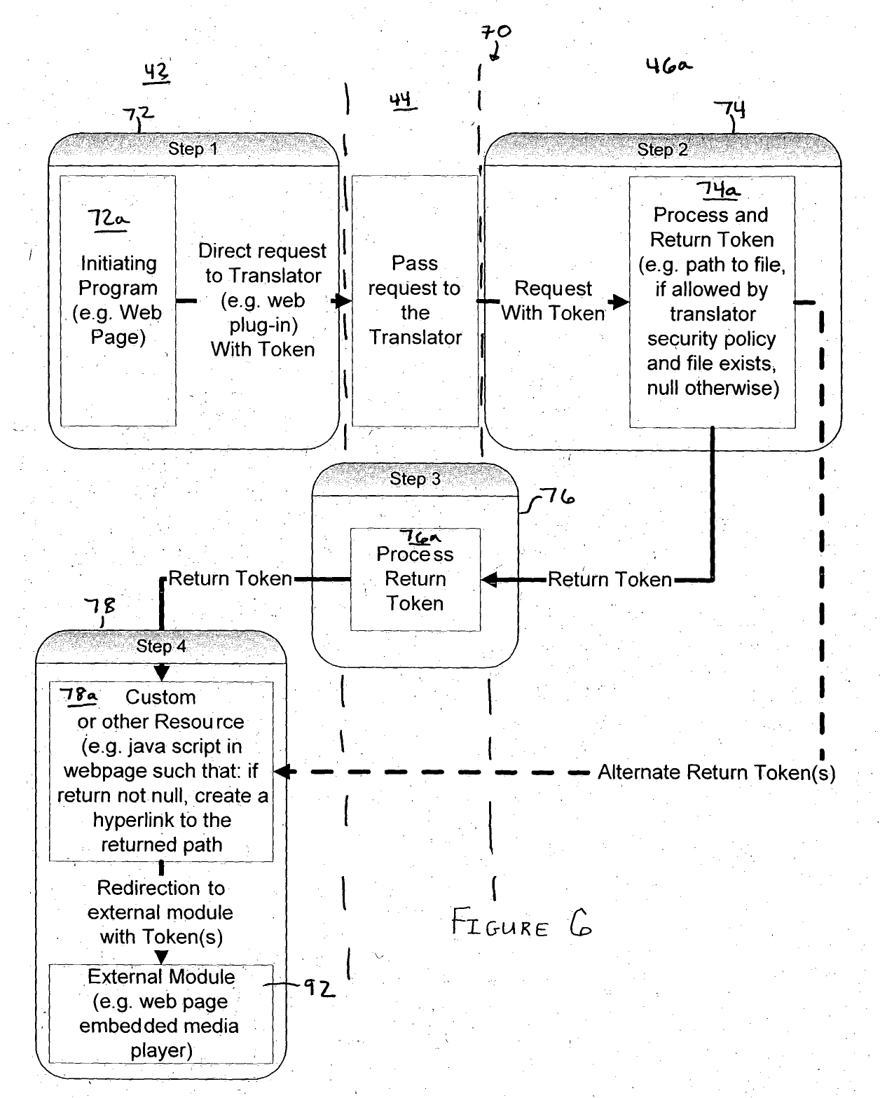

FIG. 4 illustrates another example of the method 70 for executing a local resource in accordance with the invention using a media delivery system which incorporates security features. This diagram is similar to FIG. 3 with the addition of a security policy that covers both the local machine and the network resources. Note that in the execution Step 78, the other resource could be the Initiating Program 72a, in which case the main purpose of the Invention would be the use of the Translator 46a as a “Validator” (i.e. one who validates). The Invention provides both access and security, and it's use as either for either pure translation or pure validation illustrate opposite extremes of this functionality. As shown, the request step 72 is identical to FIG. 3. In the token processing step 74, the token is processed in step 74a as above. In addition, the returned token/set of tokens has a network security policy applied to it in step 74b and the validated token is returned in step 74c or an error report is generated. This Network security policy, could, for example, check whether a file referred to by the token exists and whether it is in an allowed directory.

The validated return token or the error report is then returned to the network layer 44 which performs the return token step 76 as before. As before, the token is processed instep 76a and then a local security policy is applied in step 76b which validates the return token or generates in error report in step 80 that is returned to either a local or other level. The Local Security Policy could perform actions similar to the network security policy, or perform a distinct set of actions. One such local security policy would be to perform content type filtering, allowing only certain types of content to be passed on to the appropriate handlers. Such a policy could restrict, for example, the ability to send executables via the invention. Once the validated token/file path is received by the local user driven application 42 to perform the resource execution step 78, the same process occurs as described above for FIG. 3. Thus, using the method shown in FIG. 4, the security of the local resource access is increased. Now, another method for accessing a local resource will be described.

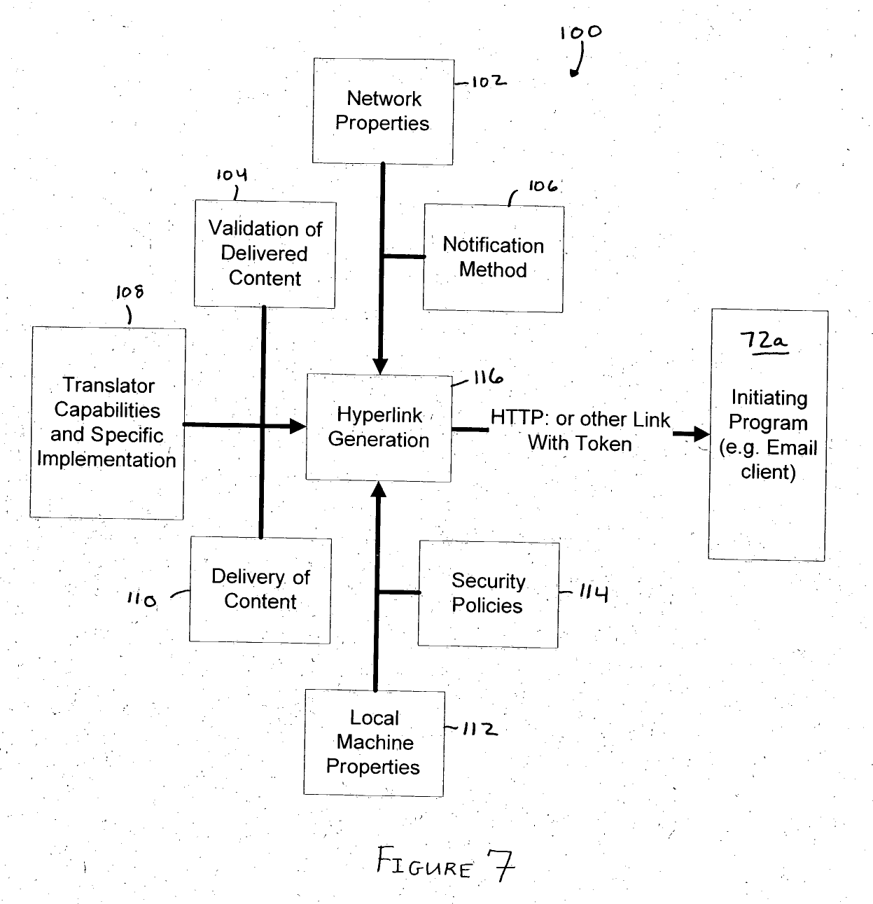

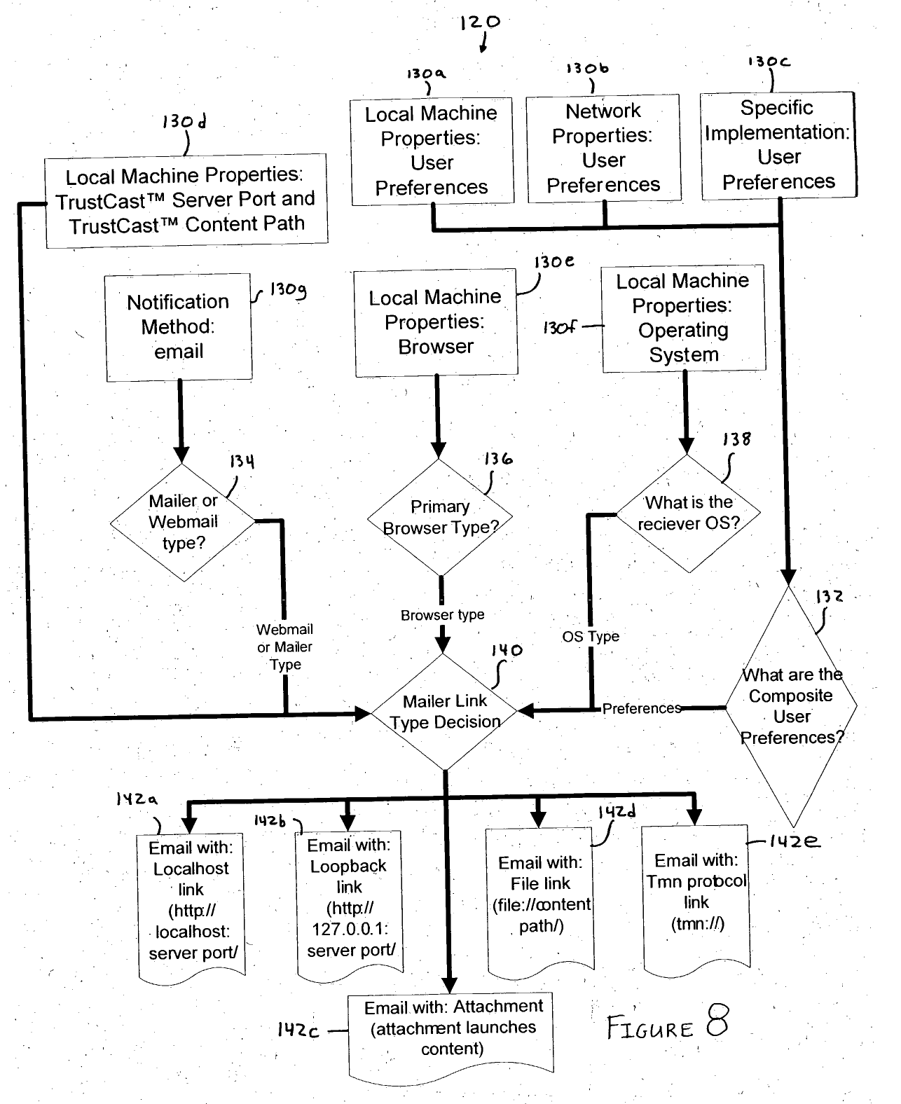

FIG. 5 illustrates an example of a network attached storage (NAS) device 90 being accessed using a local resource in accordance with the invention. The same method and method steps are shown and will not described herein except for the differences. Thus, FIG. 5 illustrates the use of a Network Attached Storage (NAS) 90 being accessed by the local resource 78a. In this diagram, the optional use of an external module (shown in FIG. 3) is replaced with the NAS 90. Since the bandwidth between the NAS and the local machine is often 10 or 100 mbps (mega-bits per second), and since this bandwidth is typically shared by few machines, there is minimal network impact involved in moving the storage of content in an external local module onto NAS. In addition there are several benefits including the delivery of content when the recipients machine in unavailable, the simplification of automated backup of the content, the restriction of the content to the local network and the potential reduction of the total number of copies of the material distributed on the networks, reducing both network load and archiving costs. Now a method of accessing the local resource using a web plug-in will be described.

FIG. 6 illustrates an example of a web-page plug-in accessing a local resource in accordance with the invention. FIG. 6 illustrates a preferred embodiment of the invention which permits a web page plug-in to access a local resource in accordance with the invention. In FIG. 6, the translator 46a is a web page plug in. An example of code that would be placed in a web page to access the plug-in is:

```
var index = document.getElementById(‘IndexDiv’);
if ( ‘ie4up’ != chkBrowser( ))
{
    index.innerHTML = g_NotSupportedText;
    SetBGImage(g_BGImage);
}
else
{
    try
    {
      var oID = new ActiveXObject(“TrustCast.IDRetrievalPlugin”);
      if(oID != null)
          {
              var path = oID.getIssuePath(window, g_MediaFile)
              if(path != “”)
              {
                  path = path.replace(/\\/g, “\\\\”);
                  index.innerHTML = g_FoundText;
                  play(path);
              }
              else
              {
                  index.innerHTML = g_NoContentText;
                  SetBGImage(g_BGImage);
              }
          }
          else // TrustCast Client Not Detected
          {
              index.innerHTML = g_NoPluginText;
              SetBGImage(g_BGImage);
          }
    }
    catch(e) // Error Trap
    {
          //alert(e.description);
          index.innerHTML = g_NoPluginText;
          SetBGImage(g_BGImage);
    }
}
```

This code loads the plug in, which in this case is an activeX control, and then calls oIDI.getIssuePath for the: content that is to be played. If an error occurs, other content is loaded onto the webpage.

In this method, the same steps 72; 74, 76 and 78 occur in the same manner. In this embodiment, the initiating program, such as a web page) 72a generates a direct request to the translator (a web page plug in in this example) with a token over the network layer 44. During the token processing step 74, the web page plug-in (the translator) processes the returns a token based on the request (wherein the web page plug-in) in which a path to the local file is returned (if allowed by the translator security policy and the file exists) otherwise a null value is returned. Step 76 is the same as FIG. 3 and will not be described herein. At the execute local resource step 78, the custom or other resource (such as a Java script in web page that creates a hyperlink to the local resource returned path unless a null is returned.) The hyperlink then redirects the user-driven local application to an external module 92, such as a web page embedded media player in this example. In summary, the above methods permit access to any local resource (such as a media file in the examples shown in FIGS. 3-6) over a network layer without the typical problems associated with typical methods. The methods described above may be used to access a variety of different local files and resources, such as video, audio, trusted software installations, presentations, html files, compressed archives, etc., and is not limited to the media file examples provided herein. Now, a method for generating a link to a local resource in accordance with the invention will be described.

FIG. 7 illustrates a method 100 for generation of a link to a local resource in accordance with the invention. In particular, FIG. 6 briefly illustrates the use of the translator to coordinate the creation of the hyperlink of the request step 72 shown in FIGS. 3-6, perhaps in conjunction with many other policies and goals. This part of the invention is highly variable depending on the specific application. In the TrustCast™ system, the hyperlinks generated to be sent in Email are either file://, http://, tmn://, or a text link directing the user to perform an action (such as opening an attachment or looking in a folder). The link is formatted to be sent in an email (the notification-method), after content is delivered and verified. The link is designed to not violate the security policies of the TrustCast™ system, while still allowing access to content. The hyperlink contains a reference to the path to the content (determined either from local machine properties or from network properties, in the case where content is stored on NAS). As shown in FIG. 7, the link generating method may take into account different variables and characteristics, such as network properties 102, validation of delivered content 104, a notification method 106 (for example chosen by the user or the initiating system), a translator capabilities and specific implementation 108, the delivery of the content 10, the local machine properties 112 and the security policies 114, in order to generate a hyperlink 116 that is passed onto the initiating program 72a. Thus, as shown, the actual generating of the hyperlink is highly flexible and adjustable to suit the particular situation. As a specific example of how the hyperlink depends on local properties, a link type of http:// is the default type to be sent in email for most windows applications, whereas this link often fails on the macintosh platform, and where tmn:// is most often successful. Now, several examples of a method for generating a link in accordance with the invention will be described.

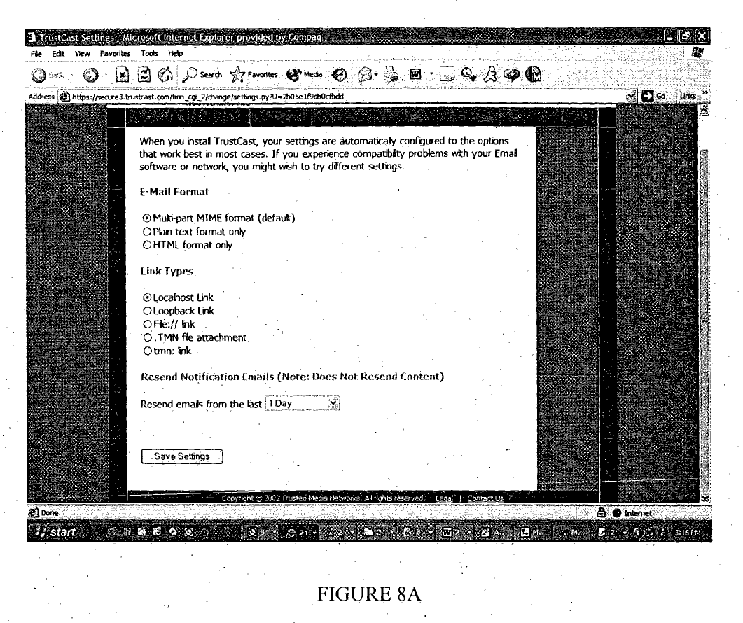

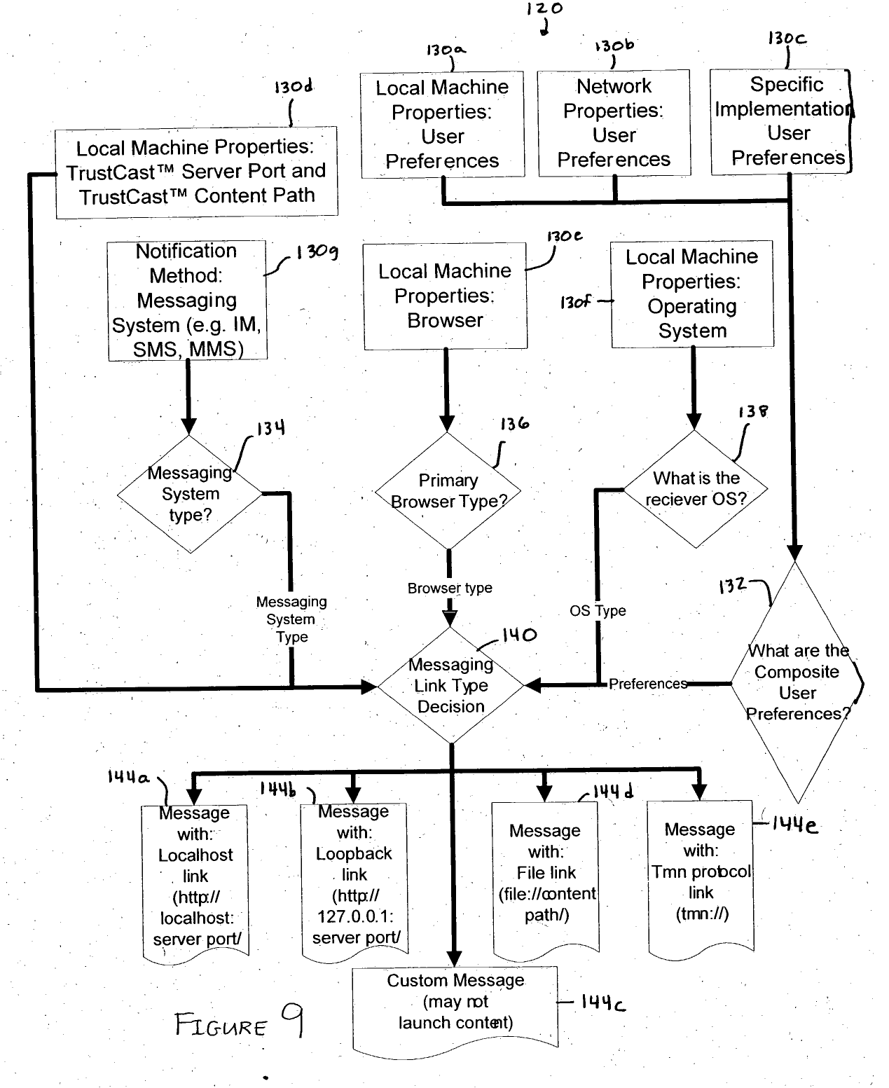

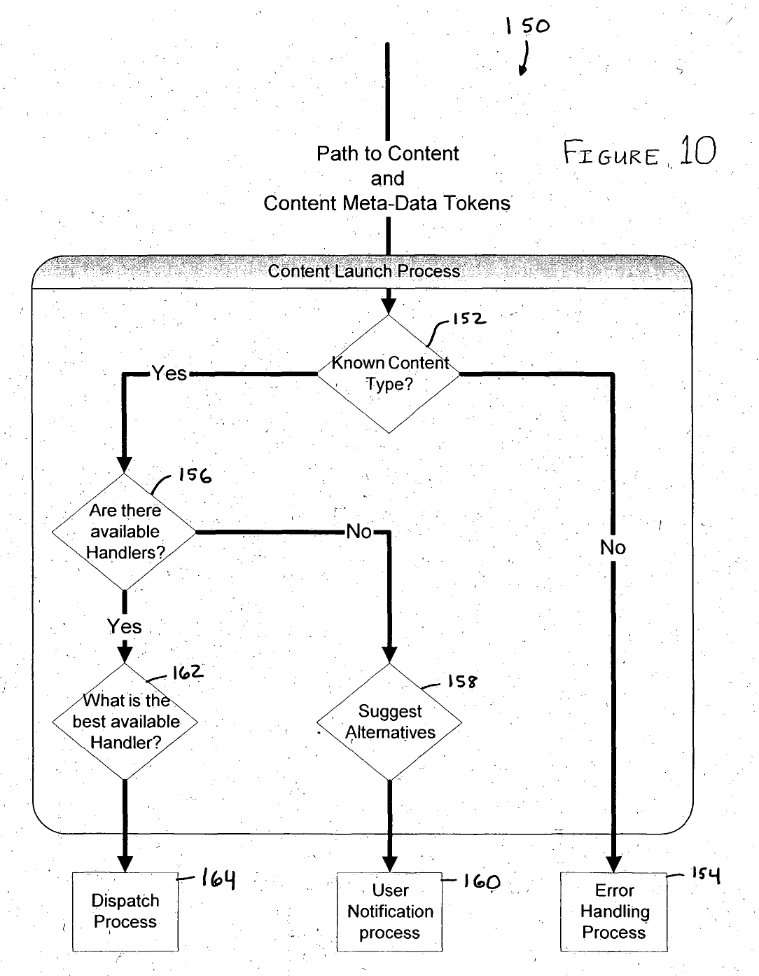

FIG. 8 is a diagram illustrating a method 120 for generating a link in accordance with the invention using an e-mail system and FIG. 9 is a diagram illustrating a method 120 for generating a link in accordance with the invention using a messaging system. As most of the steps in these two examples are duplicative, the two figures will be described together with differences being pointed out. As shown in both figures, various properties 130 are used to determine the type of hyperlink to be generated in each situation. As shown in FIGS. 8 and 9, the properties may include local machine properties 130a, including user preferences, network properties 130b including user preferences and specific implementation user preferences 130c, local machine properties 130d including a server port and a content path in these examples, local machine browser properties 130e and a local machine operating system properties 130f. As shown, the system may determine the composite user preferences 132. Examples of the user preferences are shown in FIG. 8A

Each method also determines a notification method 130g where email is selected in FIG. 8 and a messaging system (e.g., IN, SMS, MMS) is selected in FIG. 9. The methods then determine the notification system type 134, such as mailer or-webmail for FIG. 8 and IM, SMS or MMS in FIG. 9. Each method also determines the browser type in step 136 and the type of operating system (OS) receiver in step 138. Using the composite preferences 132, the notification system type, the browser type and the OS type, the method determines the type of link in step 140. Examples of several different email links 142a-e are shown in FIG. 8 and several examples of different messaging links 144a-e are shown in FIG. 9 including, for example, a localhost link, a loopback link, an email/message with attachment that launches the content, a file link and a Tmn protocol link. Now, a method for launching content in accordance with the invention will be described.

FIG. 10 is a diagram illustrating a method for launching content 150 in accordance with the invention and FIGS. 10A1-10A4 and FIGS. 10B1-10B10 combine to form an example of computer code that implements a preferred embodiment of the media player selection step 162 shown in FIG. 10. As shown, the method receives the path to the content and content meta-data tokens. In step 152, the method determines if the received content is known. If the content is not known, then an error handling process 154 is implemented; this error handling process may be to simply let the Operating System perform a default operation. If the content is known, then the method determines if there are handlers available to play the content in step 156. If not handlers (such as media players) are available, the method may suggest alternatives in step 158 and perform a user notification process 160. If there are handlers available, then the method determines the best handler in step 162 and then dispatches the process in step 164 to launch the media/content.

While the foregoing has been with reference to a particular embodiment of the invention, it will be appreciated by those skilled in the art that changes in this embodiment may be made without departing from the principles and spirit of the invention, the scope of which is defined by the appended claims.

1. A computer-implemented local resource access system, comprising:
an initiating program having an instruction that generates a request for access to a resource, the request including a token and having the form of a hyperlink; and
a translator program that receives the access request from the initiating program, the translator program further comprising instructions that generate a return token in response to the access request and instruction that return the return token to the initiating program, the return token further comprising a hyperlink containing a path to the local resource.

2. The system of claim 1, wherein the initiating program further comprises an instruction that receives the return token and an instruction that launches an application to execute the local resource pointed to by the return token.

3. The system of claim 1, wherein the translator program further comprises a local application that is part of the media delivery system.

4. The system of claim 3, wherein the translator program further comprises a local server that is part of a media delivery system.

5. The system of claim 1, wherein the translator program further comprises a web page plug-in and wherein the initiating program further comprises a web page.

6. The system of claim 1, wherein the initiating program further comprises an e-mail client application.

7. The system of claim 1, wherein the initiating program further comprises a messaging client application.

8. The system of claim 1, wherein the translator program further comprises an instruction that applies a network security policy to the return token wherein a validated return token is returned to the initiating program if the network security policy is satisfied.

9. The system of claim 8, wherein the network security policy returns an error report if the network security policy is not satisfied.

10. The system of claim 5, wherein the translator program further comprises an instruction that applies a network security policy to the return token wherein a validated return token is returned to the initiating program if the network security policy is satisfied.

11. The system of claim 10, wherein the network security policy returns an error report if the network security policy is not satisfied.

12. The system of claim 10, wherein the initiating program further comprises a java script that generates a hyperlink to the local resource if the validated return token is returned.

13. The system of claim 1, wherein the return token generation instruction further comprises an instruction for determining the type of hyperlink to be sent to the initiating program.

14. The system of claim 13, wherein the type of hyperlink comprises one of a localhost link, a loopback link, a file link and a protocol link.

15. A computer-implemented method for local resource access, comprising:
generating a request, by an initiating program, for access to a resource, the request including a token and having the form of a hyperlink;
generating a return token, by a translator program, in response to the access request; and
returning the return token to the initiating program, the return token further comprising a hyperlink containing a path to the local resource.

16. The method of claim 15 further comprising receiving the return token by the initiating program and launching an application to execute the local resource pointed to by the return token.

17. The method of claim 15 further comprising, prior to generating a return token, applying a network security policy to the return token wherein a validated return token is returned to the initiating program if the network security policy is satisfied.

18. The method of claim 17, wherein the network security policy returns an error report if the network security policy is not satisfied.

19. The method of claim 15, wherein the return token generation further comprises determining the type of hyperlink to be sent to the initiating program.

20. The method of claim 19, wherein the type of hyperlink comprises one of a localhost link, a loopback link, a file link and a protocol link.
